(19) United States
(12) Patent Application Publication
(10) Pub. No.: US 2009/0292617 A1
(43) Pub. Date: Nov. 26, 2009

(54) METHOD AND SYSTEM FOR AN INTERNET BASED SHOPPING CART TO CALCULATE THE CARBON DIOXIDE GENERATED BY SHIPPING PRODUCTS AND CHARGE FOR CARBON OFFSETS TO MITIGATE THE GENERATED CARBON DIOXIDE

(75) Inventors: Jason R. Sperling, Los Angeles, CA (US); Timothy R. Buchanan, Arvada, CO (US)

Correspondence Address: COCHRAN FREUND & YOUNG LLC, 2026 CARIBOU DR, SUITE 201, FORT COLLINS, CO, 80525, US

(73) Assignee: GreenWorld, LLC, Arvada, CO (US)

(21) Appl. No.: 12/124,615

(22) Filed: May 21, 2008

(51) Int. Cl. G06Q 30/00

(52) U.S. Cl. 705/26

(57) ABSTRACT

Disclosed is a method and system for incorporating a carbon offset calculation into a shopping cart subsystem of a merchant website that calculates an estimated cost to offset a calculated estimate of the carbon emissions generated from shipping purchased products in order to allow the incorporation of the estimated carbon offset cost into the cost for the purchased products and allocate at least a portion of the payment of the estimated carbon offset cost to an entity building, managing, or operating a carbon offsetting application. Some embodiments may permit the customer purchasing the products to optionally select to incorporate the carbon offset costs in the costs for the purchased products. The estimate of carbon emissions generated calculation is based on specific information for the purchased products and the selected shipping methods for shipping the purchased products such as the shipping weight of the purchased products, a distance the purchased products are being shipped, and a designation of the shipping or transportation method. Additional embodiments may include dimensional weights of the purchased products, additional factors to account for the specific aspects of the selected transportation method for shipping the purchased products, and permitting the customer to select a specific carbon offsetting application to fund.

### BACKGROUND OF THE INVENTION

Over the past several decades the concept of global warming, and the potential consequences of global warming, has gone from a relatively unknown idea to a problem recognized by the international community. One identified cause of global warming is the increase in Greenhouse Gases in the atmosphere brought about by human activities. Of the Greenhouse Gases (e.g., CO₂, CH₄, N₂O, HFCs, PFCs, SF₆, etc.), Carbon Dioxide (CO₂) is the largest contributor to man-made climate change. Important research and regulatory proposals were reached at the 1997 Kyoto Conference on Climate Change that ultimately resulted in the Kyoto Protocol as a guideline for target carbon dioxide emission reductions. Potential carbon dioxide emitting sources from human activity include nearly all burning of fossil fuels such as burning oil, gasoline, diesel, jet fuel, natural gas, coal, and the like. Electrical generation and transportation are two of the largest human activities that utilize the burning of fossil fuels. Transportation in particular is almost entirely reliant on fossil fuels. Transportation may be further sub-classified into personal transportation, public transportation of individuals, and transportation for shipping goods.

A globally recognized method to address human contributions to atmospheric greenhouse gases is through the use of “carbon offsets.” As noted above, one of the primary greenhouse gases that humans emit to the atmosphere is carbon dioxide. Carbon offsets are used by people and/or entities that cause carbon dioxide emissions in the process of completing an activity, but wish to offset the emissions of carbon dioxide by purchasing an offset of the emitted carbon dioxide. A governmentally regulated medium of buying and selling carbon offsets is performed using “carbon credits.” The emissions of carbon dioxide may be offset by a number of non-carbon emitting energy generation technologies. Carbon dioxide may also be actively removed from the atmosphere by carbon sequestration endeavors. Examples of energy generation technologies that do not emit carbon dioxide or other greenhouse gases include technologies that capture solar energy, wind energy, geothermal energy, tidal energy, ocean/water wave energy, and other such natural energy sources. One example of carbon sequestration is biological matter that absorbs carbon dioxide out of the atmosphere, such as trees and other plant life. Another example of carbon sequestration technique may be referred to as geological carbon sequestration. Geological carbon sequestration is implemented when carbon dioxide is physically captured and then pumped into empty underground spaces, such as those areas left empty after pumping oil out of the ground.

Throughout the world, many businesses and consumers are looking for ways that they can help minimize the carbon contributions due to the businesses' and consumers' activities. While carbon offsets are a globally recognized method to offset carbon emissions, the actual public knowledge of carbon offsets and how to purchase carbon offsets is minimal. Although many businesses and consumers are becoming aware of potential global warming problems, the businesses and consumers do not presently have the ability to minimize carbon emissions in the majority of daily transactions short of “sitting in the dark and doing nothing.” The lack of knowledge of carbon offsets and the general lack of ability to minimize carbon contributions without severe economic consequences have left most businesses and consumers in a quandary between helping attack potential global warming problems and the potential negative impact of taking action against global warming may have on economic vitality.

### BRIEF DESCRIPTION OF THE DRAWINGS

In the drawings,

FIG. 1 is a high level diagram of the operational process of the user/customer experience for an embodiment.

FIG. 2 is a high level diagram of the merchant integration process for an embodiment.

FIG. 3 is an illustration of an example customer interface screen to display in a merchant shopping cart for an embodiment.

FIG. 4 is a high level deployment diagram of the deployment of components for an embodiment.

FIG. 5 is a high level site and structure diagram for a merchant control portion of an embodiment.

FIG. 6 is a high level site and structure diagram for a master control portion of an embodiment.

FIG. 7 is a high level site and structure diagram for a web service portion of an embodiment.

FIG. 8 is a high level component diagram of software components for an embodiment.

FIG. 9 is a high level object diagram of software objects for an embodiment.

FIG. 10 is a high level sequence diagram of the sequence of operations for an embodiment.

FIG. 11A is page 1 of a high level flow chart of a measurement and calculation method of an embodiment.

FIG. 11B is page 2 of a high level flow chart of a measurement and calculation method of an embodiment.

FIG. 11C is page 3 of a high level flow chart of a measurement and calculation method of an embodiment.

FIG. 11D is page 4 of a high level flow chart of a measurement and calculation method of an embodiment.

FIG. 11E is page 5 of a high level flow chart of a measurement and calculation method of an embodiment.

FIG. 11F is page 6 of a high level flow chart of a measurement and calculation method of an embodiment.

FIG. 12A is page 1 of a table of example locations of airfreight hubs by shipping carrier for an embodiment.

FIG. 12B is page 2 of a table of example locations of airfreight hubs by shipping carrier for an embodiment.

FIG. 13 is a table of circuitry factors for an embodiment.

FIG. 14 is a table of shipping mode options based on carrier product names for an embodiment.

FIG. 15 is a table of potential variables by source (merchant or offset system) for carbon dioxide emissions estimate calculation for an embodiment.

FIG. 16 is a table of selected assumptions of transportation emission factors for an embodiment.

FIG. 17A is tables of various short-distance road transportation emission factors for an embodiment.

FIG. 17B is additional tables of various short-distance road transportation emission factors for an embodiment.

FIG. 18A is tables of various long-distance road transportation emission factors for an embodiment.

FIG. 18B is additional tables of various long-distance road transportation emission factors for an embodiment.

FIG. 19 is a table of rail transportation emission factors for an embodiment.

FIG. 20 is a table of air transportation via an Airbus 300 airplane emission factors for an embodiment.

FIG. 21 is a table of air transportation via a DC-10 airplane emission factors for an embodiment.

FIG. 22 is a table of air transportation via a Boeing 767 airplane emission factors for an embodiment.

### DETAILED DESCRIPTION OF THE INVENTION

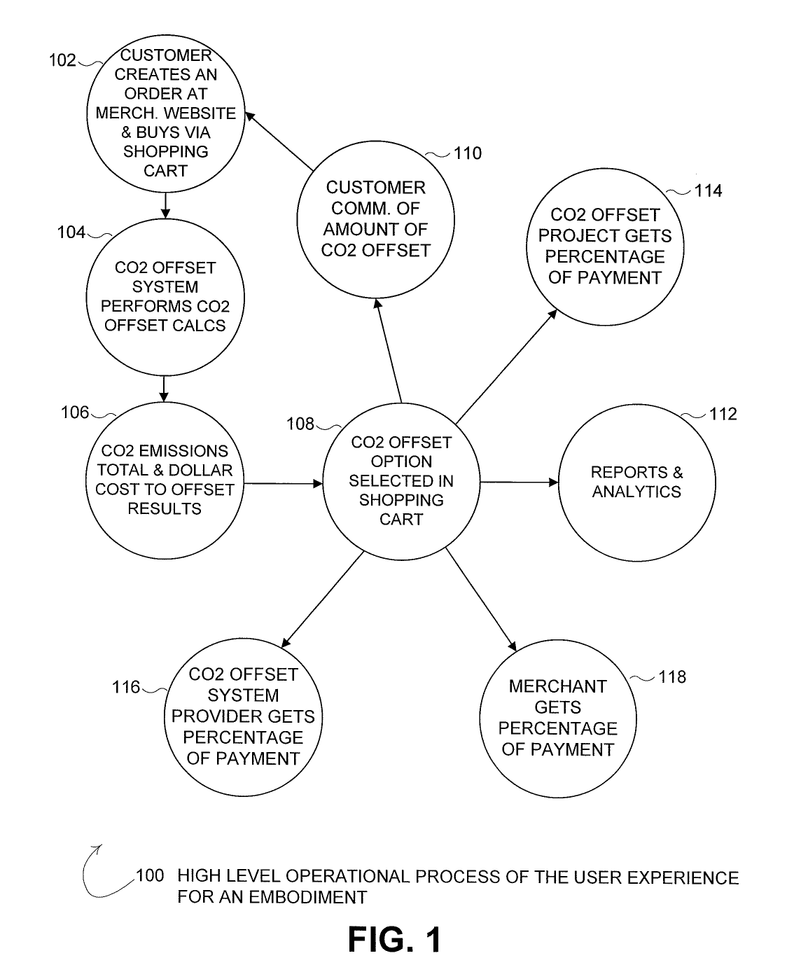

FIG. 1 is a high level diagram 100 of the operational process of the user/customer experience for an embodiment. At 102, a customer creates an order to purchase a merchant's products at a merchant's website. At the end of the purchase process 102, the buyer moves to the shopping cart subsystem of the merchant website to complete the purchase and complete shipping information to get the purchased products delivered to the customer. At 104, a carbon dioxide offset system performs calculations to determine an estimated amount of carbon dioxide emissions generated by shipping the purchased products to the customer and a related dollar, or other monetary currency, cost to offset the carbon dioxide emissions produced from shipping the purchased products. At 106, the final estimated carbon dioxide emissions and the monetary cost to offset the estimated carbon dioxide emissions results are complete and made available for use by the carbon dioxide offset system. At 108, a customer selects a “carbon offset” or “carbon dioxide offset” option in the shopping cart in order to offset the carbon dioxide generated from shipping products. Various embodiments may make the decision to include carbon offset costs in the shipping costs optional for the customer. Other embodiments may permit the merchant to choose whether to include carbon offset costs in the cost of shipping, and at some point, governments or regulatory entities may mandate that carbon offset costs are included in the costs of shipping. At 110, the final estimated carbon dioxide emissions and monetary cost are communicated to the customer. Various embodiments may communicate the final estimated carbon dioxide emissions and carbon offset monetary cost through the shopping cart subsystem of the merchant website. Other embodiments may communicate the final estimated carbon dioxide emissions and carbon offset monetary cost through other means. Some embodiments may only report the carbon offset monetary cost and not the estimated amount of carbon emissions. At 112, various reports and analytics are provided to the merchant and/or the carbon offset system provider to enhance system usability and potentially to meet regulatory requirements.

At 114, a percentage of the payment from the customer for carbon offsets is allocated to a carbon offset project. Some embodiments may permit the customer to select the carbon offset project to fund while other embodiments may apply the carbon offset payment to generally available carbon offsets used for funding carbon offset organizations. Some embodiments may apply the carbon offset payment to generally available regulated and un-regulated “carbon credits” that are purchased as the medium of exchange for funding carbon offsetting applications. Still other embodiments may offer various classes of carbon offset applications, such as wind or solar energy, while other embodiments may permit the customer to select to fund a specific project such as the wind farm at specified or general locations. Various embodiments may combine the types of potential carbon offset application selections available to a customer as desired by a system developer or merchant. Some of the potential carbon offsetting applications that may be funded by the carbon dioxide offset system include: wind energy production, solar energy production, geothermal energy production, tidal energy production, ocean/water wave energy production, biological matter carbon dioxide sequestration, tree carbon dioxide sequestration, geological carbon sequestration, general carbon offsets, and/or a specific individual carbon offset application. At 116, the carbon dioxide offset system provider is allocated a percentage of the overall carbon offset payment received from the customer. For various embodiments, allocating a portion of the payment to the carbon dioxide offset system provider may be optional if the carbon dioxide system provider either performs the task for free or if the carbon dioxide system provider is reimbursed using a different payment scheme. At 118, the merchant may be allocated a percentage of the overall carbon offset payment. The carbon dioxide offset project 114 is allocated a percentage of the carbon offset monetary cost paid by the consumer to purchase carbon offsets. A percentage of the carbon dioxide offset monetary cost paid by the consumer may be allocated to the carbon dioxide offset system provider to pay overhead costs of operating the system and to provide a profit motive for the carbon dioxide system provider to expand the carbon dioxide offset system. A percentage of the carbon dioxide offset monetary cost paid by the consumer may be paid to the merchant 118 to encourage the merchant to include the carbon dioxide offset system in the merchant's website. For some embodiments, the merchant and/or the carbon dioxide offset system provider may choose not to receive a percentage of the carbon dioxide offset payment. For additional embodiments, the merchant may choose to match the allocated payment or a portion of the allocated payment made by the consumer. Further, one of the primary values of including the carbon dioxide offset system on a merchant website may be the public relations boost a merchant receives by being perceived as a proactive, environmentally friendly company.

The amounts allocated from the carbon offset payment to each party may be paid using a variety of methods. An embodiment may immediately pay the allocated portion of a carbon offset payment to each party at the time the payment is made by the consumer. An embodiment may consolidate all payments for a period time, such as a month, and pay the consolidated amounts allocated to each party at the end of the month. Other embodiments may combine aspects of immediate payment with aspects of consolidated payments depending on the party being paid and the contractual agreements between the various parties. Due to the nature of the carbon offset projects, embodiments may pre-purchase the carbon offsets in bulk and then sell the carbon offset in micro-transactions. Due to the nature of merchant systems, the merchant may consolidate all payments made by the consumer for a period of time, such as a month, and pay the consolidated amounts to the offset system provider at the end of the month. Conversely, embodiments may sell carbon offsets in micro-transactions and then buy the carbon offsets in bulk once the payment from the micro-transactions has been collected. The bulk purchase of carbon offsets may be delayed until sufficient micro-transaction sales have been made to purchase a large amount of carbon offsets. Where possible, carbon offsets may be purchased on a one for one basis at the time of the micro-transaction, thus, payment is delivered immediately. The disclosed methods of payment are not intended to be a comprehensive list of payment methodologies. For the disclosed system, payment methodologies that eventually cause the designated party to receive the benefit of the allocated portion of the payment for the designated party satisfy the needs of the system.

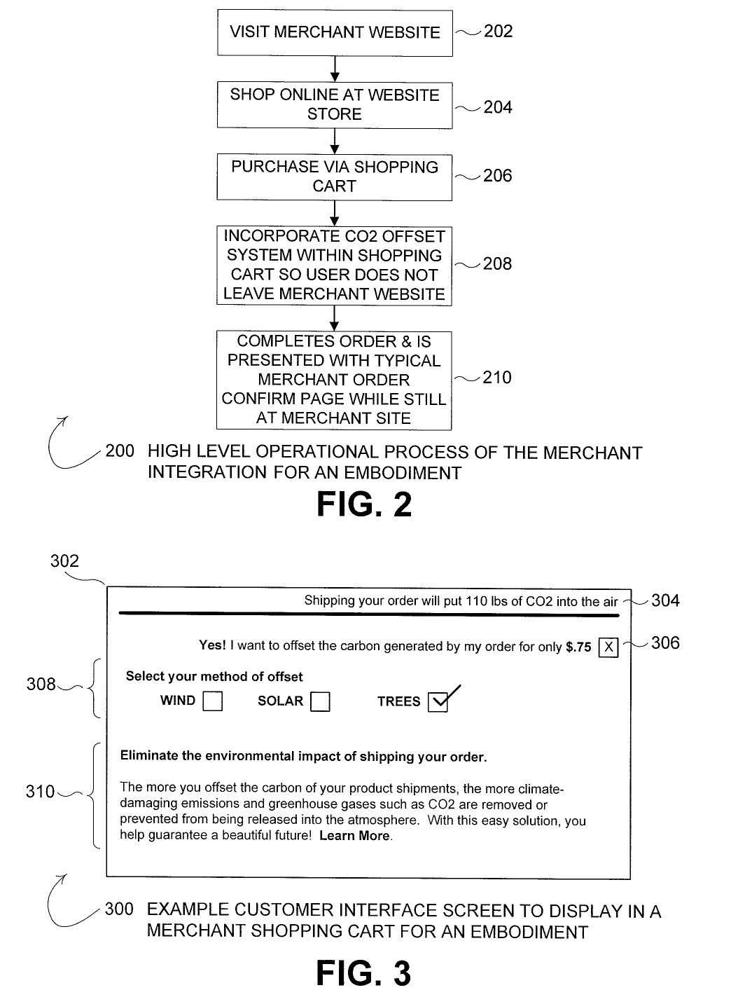

FIG. 2 is a high level diagram 200 of the merchant integration process for an embodiment. From the perspective of the merchant, at 202, a customer visits the merchant website. At 204, the customer shops online at the merchant's website store. At 206, the customer purchases at least one product selected at 204 via a shopping cart subsystem included in the merchant's website. At 208, the carbon dioxide offset system is incorporated within the shopping cart subsystem so the customer does not leave the merchant website to purchase the carbon offsets. Thus, a customer is presented the opportunity to purchase carbon offsets in a single, seamless transaction that appears to the customer to be a fully integrated function of the merchant's website. At 210, the customer completes the order and is presented with the merchant's typical order confirmation page while still on the merchant's website. The merchant is able to supply shipping information to the carbon dioxide offset system in order to permit the carbon dioxide offset system to make accurate estimates of the actual carbon emissions to ship a particular product, or group of products, rather than using a fraction of the overall, average carbon dioxide generated by all shipping for a particular merchant. Shipping information that may be provided to the carbon dioxide offset system from the shopping cart may include, but is not limited to: product weight, product weight type (such as grams, lbs, or tons), product identification (such as Shop Keeping Unit (SKU) or other number specific to the merchant), the actual distance of the shipment, the origination location that the product will ship from, a destination where the product is to be shipped, multiple locations where the product will pass through during shipment (such as ocean ports, airports, distribution centers, etc.), the transportation method utilized to ship the product, emission identification, and a merchant identification. Various embodiments may utilize a subset of the listed shipping information and may also add additional information to address additional and/or different aspects of shipping. For instance, some embodiments may also incorporate calculations based on a dimensional weight of a product. Various embodiments may handle a variety of shipping situations that may be present for a particular merchant or shipping carrier. For instance, a merchant may have multiple warehouses that a product may ship from and the carbon offset system may be responsible for selecting the warehouse that gives the shortest shipping distance. In other cases, the merchant may report the specific warehouse that will ship a product or group of products and the carbon offset system will calculate the distance from the warehouse to the destination. In some cases, the carbon offset system may decide which warehouses are potential shipping origins based on product identification (e.g. SKU or other identifier). In some cases, the carbon offset system may calculate the distance based on an origin location and a destination location. In still other cases, the merchant and/or shipping carrier may supply the shipping distance to the carbon offset system. Other methods of calculating a distance may be utilized by a system developer as desired by the system developer.

In the case when actual distance is not able to be provided to the carbon offset system from the shopping cart, then various embodiments may calculate a straight-line distance based on the origination location and the final destination for a product. To account for the circuitous nature of transportation systems, a circuitry factor may be included in a distance calculation to account for the extra miles a product is transported on streets that do not permit a vehicle to drive a straight line between the origination point and the destination as well as the potential extra miles an airplane might fly to accommodate a hub system used by a transportation company where a product is shipped first to a hub before being delivered to the destination. Calculations may also take into account that shipping a product may involve the use of several types of transportation. For instance, a short-distance road truck may take a product from the origination location to an airport, then an airplane may be used to transport the product from the airport to an airport used as a hub, and then to a second airport, and finally a short-distance road truck may be used to transport the product from the second airport to the destination. Potential types of transportation may vary, but common types encountered in today's shipping environment include: short-distance trucking, long-distance trucking, railroads, airplanes, and water born ships. Most goods delivered from a merchant to a single consumer do not utilize water born ships, but certain large and/or foreign products may be shipped via water born ships, thus, a carbon dioxide system may need to account for water born ships in some embodiments.

Calculations may also take into account factors for the model year of transportation vehicles, the capacity of transportation vehicles, the utilization of transportation vehicles, the empty miles of transportation vehicles, and factors for differentiating between various shipping companies. The model year may be a specific year if the actual vehicle used to ship the product is known to the carbon dioxide calculation system, or the model year may be a fleet average for a selected transportation company. The capacity of the transportation vehicles defines the potential amount of cargo a vehicle may carry. The utilization of the transportation vehicle measures the average amount of cargo carried by a vehicle for each mile traveled. For instance, a shipping truck that goes one direction completely full, but returns empty would have a utilization of 50%. The empty miles percentage measures the percentage of unutilized capacity for a transportation vehicle. The empty miles percentage plus the utilization percentage typically add up to one hundred percent. Thus, for the example of a shipping truck going one direction completely full, but returning empty, the empty miles percentage would be 50%. If the same shipping truck were to go one direction completely full, but return 50% full, the utilization would rise to 75% and the empty miles percentage would drop to 25%. Obviously, shipping companies strive to achieve a 100% utilization percentage, but roughly 90% is about the best that may be achieved on a regular basis.

The precision of the estimate calculations for the carbon dioxide generated by shipping a product may be affected by the information made available by the merchant. If the merchant provides the exact routes for shipping a product, the exact or nearly exact mileage of the circuit for a shipped product may be incorporated into the carbon dioxide emission estimation calculation. Similarly, if the precise model year and vehicle type information for the vehicle(s) transporting a product are provided, then the calculation may take the specific information into account when calculating the estimated carbon dioxide emissions for shipping a product. Similarly, if the exact vehicle utilization percentage is known, then the calculations may utilize the exact vehicle utilization percentage. However, the typical merchant or shipping company do not know the precise vehicles by which a product will be shipped at the time the product is purchased by the customer, so embodiments may utilize average fleet model years, average vehicle type utilization, and average circuit mileage adjustments. Currently, short-distance trucking operations typically use a U.S. Environmental Protection Agency (EPA) class 2b truck while long-distance trucking operations typically use an EPA class 8b truck. A class 2b truck is defined to have a capacity between 8,500 and 10,000 pounds. A class 8b truck is defined to have a capacity of over 60,000 pounds.

FIG. 3 is an illustration 300 of an example customer interface screen 302 to display in a merchant shopping cart for an embodiment. Other embodiments may display and/or incorporate the carbon dioxide offset system into the merchant shopping cart differently than the display 302 illustrated in FIG. 3. The display 302 illustrated is of an embodiment that permits a customer to optionally select to include the carbon offset cost in the cost of the product order. The display 302 shows the customer the total amount of carbon dioxide estimated to be generated by shipping the product at 304. At 306, the carbon dioxide offset cost to offset the estimated carbon dioxide generated by shipping the product is shown to the customer and the customer is given the opportunity to choose whether or not to include the carbon dioxide offset cost in the total cost of the product. At 308, the customer is asked to select a desired method to offset the carbon dioxide generated by shipping the product. For the embodiment illustrated 300, the potential carbon offsetting applications include: wind energy production, solar energy production, and tree carbon sequestration. Other embodiments may include other carbon offsetting applications. Some potential carbon offsetting applications include, but are not limited to: wind energy production, solar energy production, geothermal energy production, tidal energy production, ocean/water wave energy production, bio matter carbon dioxide sequestration, tree carbon dioxide sequestration, geological carbon sequestration, general carbon offsets, and/or a specific individual carbon offset application. At 310, the carbon dioxide system display 302 delivers an explanation of how the carbon dioxide system works and why the customer should consider including the carbon dioxide offset cost in the total order cost.

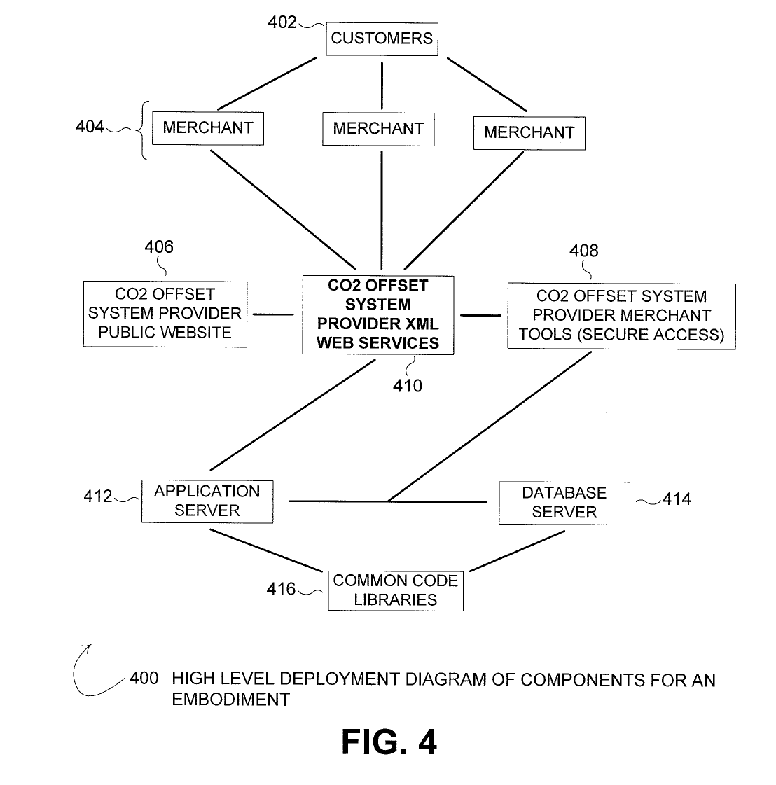

FIG. 4 is a high level deployment diagram 400 of the deployment of components for an embodiment. Other embodiments may deploy components in a variety of configurations as desired by the system developer. Various embodiments may utilize any web enabled network available to interconnect the various components. The most common web enabled network available world wide is the public Internet system. For the embodiment shown in FIG. 4, customers 402 communicate with one or more merchants 404. The merchants communicate with the carbon dioxide offset system provider eXtensible Markup Language (XML) web services 410 to obtain the carbon offset displays and system that are included in the merchants' 404 shopping cart applications. The carbon dioxide offset system provider may also provide a public website 406 for customers and merchants to obtain information about the carbon dioxide offset system and/or to run sample applications. Merchant tools 408 may also be provided for merchants to monitor the use of the carbon dioxide offset system by merchant customers. The merchant tools may have secure access to ensure that only the proper personnel from a merchant are able to view potentially proprietary information about merchant sales and carbon dioxide offset system usage. Both the carbon dioxide offset system public website 406 and the merchant tools 408 may interact with the carbon dioxide offset system provider XML web services 410 to obtain carbon dioxide offset information. The carbon dioxide system provider XML web services may access an application server 412 that runs the carbon dioxide system programs. The application server 412 may obtain calculation factors and other carbon dioxide offset information from a database server 414. The application server may also store information from operations using the database server 414. The merchant tools 408 may directly access the application server 412 and the database server 414 without having to pass through the carbon dioxide offset system provider XML web services 410. Both the application server 412 and the database server 414 may use common code libraries 416 to make the programming and implementation of the application server 412 and database server 414 easier to complete and more consistent in operation. Some embodiments may include both the database server 414 and the application server 412 on a single computer, while other embodiments may have a separate computer running each server, and still other embodiments may user multiple computers to run either or both servers. Various embodiments may include all data storage and retrieval in the application server 412 and eliminate the necessity for a database server 414. The common code libraries 416 are included to ease the programming burden to create the server systems, but an embodiment may create server systems without using common code libraries 416.

Various embodiments may include Software Development Kits (SDKs) and/or plugins to assist system developers in creating applications that include the carbon dioxide offset system in the merchant shopping cart applications. An SDK may help a developer program a new software application. A plugin is typically a complete application that hooks, or links, into a parent application that has provided the hooks/interfaces for the plugin to communicate and interact with the parent application. For instance, a shopping cart application may provide hooks/interfaces for a child application to work and appear as part of the shopping cart application to the shopping cart application user.

The carbon dioxide system provider public website 406 may be used to advertise the carbon dioxide offset system as well as to provide support and access to current system users. One embodiment of the carbon dioxide system provider public website 406 may include screens to describe how the carbon dioxide offset system works. Additional screens may include marketing material for the carbon dioxide offset system provider such as an explanation of the differences between the carbon dioxide offset system provider and competitors as well as articles and publications about the carbon dioxide offset system. An emissions calculator may be included in the website to demonstrate how estimated carbon emissions and the correlating carbon offset costs are calculated. A Frequently Asked Questions (FAQ) section and other help/support screens may also be made available.

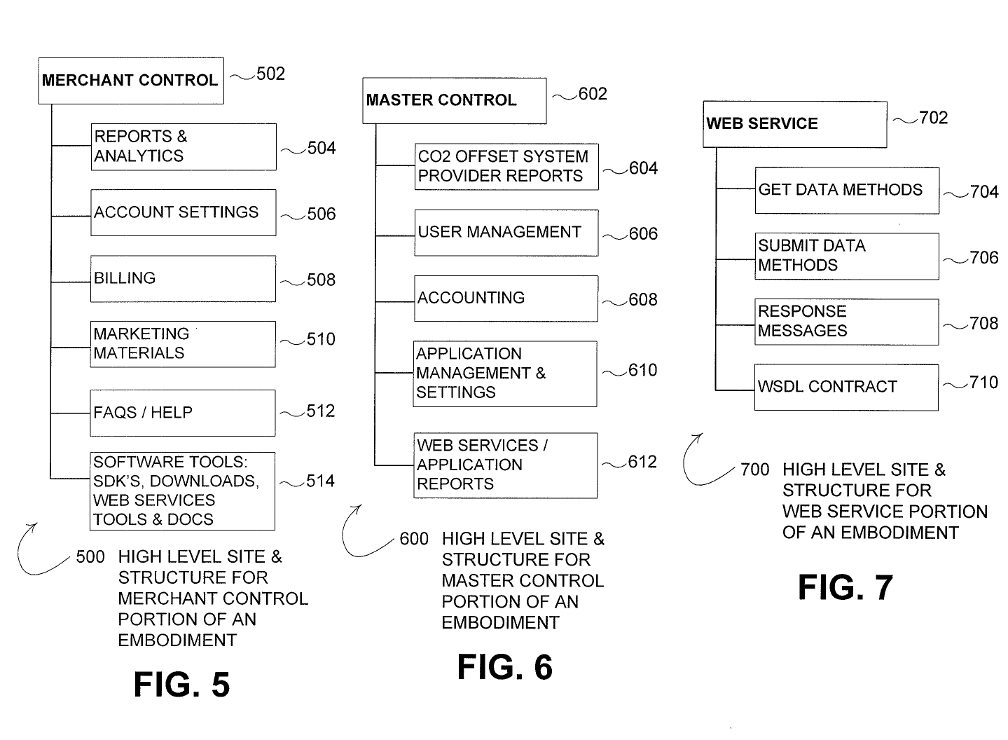

FIG. 5 is a high level site and structure diagram 500 for a merchant control portion 502 of an embodiment. The disclosure with respect to FIG. 5 describes a single embodiment of a system that implements a carbon dioxide offset system. Various embodiments may implement a carbon dioxide offset system using different structures than the structure shown in FIG. 5. The merchant control portion 502 of the embodiment of FIG. 5 includes subsystems for reports and analytics 504, account settings 506, billing 508, marketing materials 510, FAQs/help 512, and software tools 514 such as SDKs, downloads, web services tools and documentation 514. Access to the merchant control 502 will typically be restricted to administrators. The merchant control 502 may give users the ability to manage carbon dioxide offset pricing, update website content and carbon dioxide offsetting project selection, manage screen layout, view analytics and reports, view and update billing information, and create reports.

The reports and analytics subsystem 504 may permit a merchant control 502 user to view sophisticated analytics on customer behavior and system performance. Potential reports and report data include: time, behavior, click through, product information, customer/user history demographics, carbon offsetting project, sales, cost, sales tax, calculation type, offset amount data, plugin, layout type, failed and complete transactions, transaction status, rate type, pricing and code information, and research reports.

The account settings subsystem 506 may be broken down into several additional areas such as emission calculation data manager, price manager, carbon dioxide offsetting application project manager, and layout manager. An emission calculation data manager may be used to set the default settings for various transportation types, such as air, truck, rail, and ocean/ship. Emission profiles may also be added, edited, or deleted based on a specific Stock Keeping Unit (SKU), by a specific warehouse, or by an alternate code. Emissions related to additional shipment legs, such as an international shipping leg, may also be added by SKU, by specific warehouse, or by an alternate code. Transportation types may also be added, edited, and deleted as necessary. Various amounts for product weight information may be managed via the emission calculation data manager. Weight for a product may be maintained as an average weight for the type of product. For instance, a piano may have an average weight for pianos while a t-shirt may be assigned an average weight for t-shirts. Weight for a product may be stored and retrieved by SKU and/or by an alternative code system. The empty miles for a transportation system may be kept per shipper or may be incorporated by the volume of the package (i.e., the dimensional weight of the package). The emission calculation data manager may also maintain data needed to calculate distance. Some merchants may have a single point of origin, others may have multiple warehouses and ship from the closest warehouse to the destination, and still others may associate specific SKUs with particular warehouses.

A price manager for the account settings subsystem 506 permits the merchant control 502 user to adjust the price of the carbon offsets purchased by the customer. Prices may be adjusted based on analytics feedback, profit goals, and other considerations. A carbon dioxide offsetting application project manager for the account settings subsystem 506 may be used by merchant control 502 users to add, remove, edit and/or prioritize carbon dioxide offsetting projects made available to customers. A layout manager for the account settings subsystem 506 may permit merchant control 502 users to control the graphical layout of the customer interface that appears for customers in the merchant's shopping cart.

The billing subsystem 508 may permit a merchant control 502 user to access billing and account information. Billing data may be viewed and exported from the billing subsystem 508. Payment plans and payment methods may be adjusted from the billing subsystem 508.

The marketing materials subsystem 510 may permit a merchant control 502 user to view, modify, add, or delete marketing material for the carbon dioxide offset system. Some marketing material may be view only, while other marketing material may be made available for a merchant control 502 user to incorporate into a merchant website.

The FAQs/help subsystem 512 may permit a merchant control 502 user to access software and other information on how other people use the carbon dioxide offset system, including case studies, test cases, and help documentation.

The software tools subsystem 514 may permit a merchant control 502 user to have access to various software programming tools, such as, but not limited to: SDKs, downloads, and web services tools and documentation.

FIG. 6 is a high level site and structure diagram 600 for a master control portion 602 of an embodiment. The disclosure with respect to FIG. 6 describes a single embodiment of a system that implements a carbon dioxide offset system. Various embodiments may implement a carbon dioxide offset system using different structures than shown in FIG. 6. The master control portion 602 of the embodiment of FIG. 6 includes subsystems for carbon dioxide offset system provider reports 604, user management 606, accounting 608, application management and settings 610, and web services/application reports 612. Via the various subsystems 604-612 of the master control 602, master control 602 users may be permitted to obtain reports on the carbon dioxide offset system operation, manage system users, manage payment accounting, manage the carbon dioxide system application settings, and obtain reports on web services and application server operations.

FIG. 7 is a high level site and structure diagram 700 for a web service portion 702 of an embodiment. The disclosure with respect to FIG. 7 describes a single embodiment of a system that implements a carbon dioxide offset system. Various embodiments may implement a carbon dioxide offset system using different structures than shown in FIG. 7. The web service portion 702 of the embodiment of FIG. 7 includes subsystems for get data methods 704, submit data methods 706, response messages 708, and Web Services Description Language (WSDL) contract 710. Get data methods 704 provides methods for a merchant to retrieve data from the carbon dioxide offset system provider website and servers. Submit data methods 706 provides methods for a merchant to send/submit data to the carbon dioxide offset system provider, such as, but not limited to data specific to an order transaction that is to be recorded in a database. Response messages 708 are messages sent by the carbon dioxide offset system in response to inquiries, such as, but not limited to: data, data confirmation, and data details (e.g., identification numbers). WSDL contract 710 provides information that explains how the web service is used by a merchant.

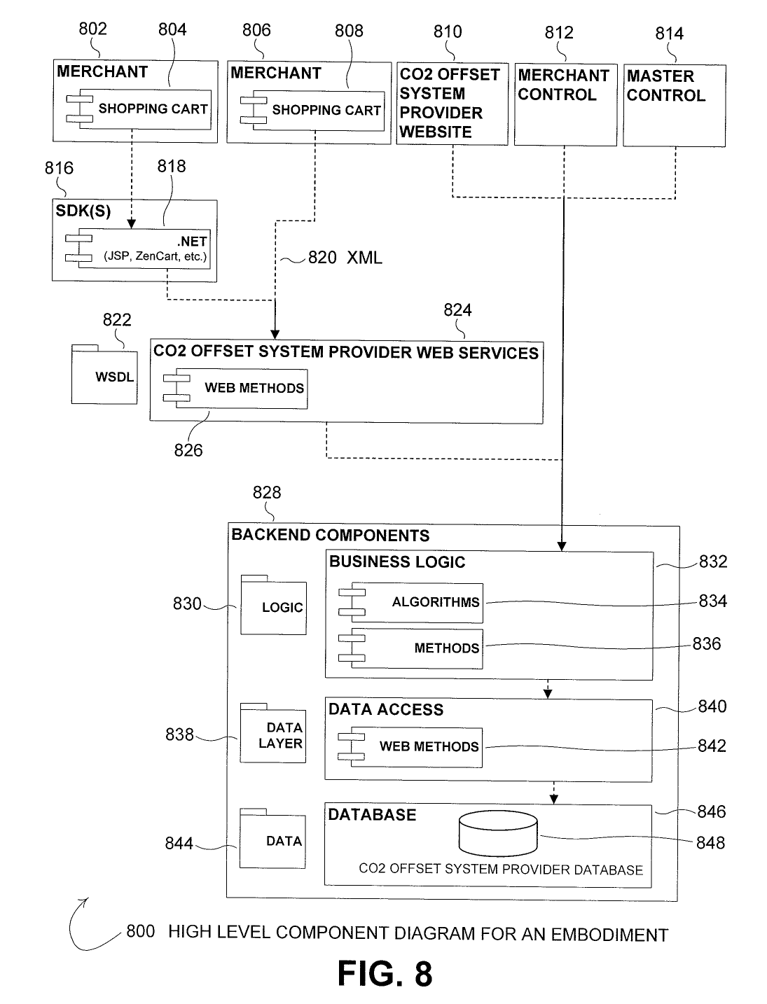

FIG. 8 is a high level component diagram 800 of software components for an embodiment. FIG. 8 discloses a Unified Modeling Language (UML) component diagram describing the software components for an embodiment. Software may be implemented in many different ways and the disclosure with respect to FIG. 8 is provided to illustrate how one embodiment may choose to set up the various software components with the understanding that other embodiments may implement software components in a different manner. Each merchant component 802, 806 contains a shopping cart component 804, 808. One instance of the shopping cart component 804 utilizes one or more SDK components 816 to interface with the carbon dioxide offset system provider web services component 824. An SDK component 816 may include a sub-component such as the .Net component 818 shown in FIG. 8. Other potential SDK sub-components include, but are not limited to: Java Server Pages (JSP), ZenCart, and other web service tools. Another instance of the shopping cart component 808 interfaces with the carbon dioxide offset system provider web services 824 using XML formatted messages 820. The carbon dioxide offset system provider web services component 824 utilize a WSDL format 822. The carbon dioxide offset system provider web services component 824 includes web methods components 826. The carbon dioxide offset system provider web services component 824, the carbon dioxide system provider website component 810, the merchant control component 812, and the master control component 814 each interface with the backend components 828. The backend components 828 include business logic components 832, data access components 840, and a database component 846. The business logic component 832 utilizes a logic format 830. The business logic component 832 includes algorithms 834 and methods 836 components. The data access component 840 utilizes a data layer format 838. The data access component 840 includes web methods components 842. The database component 846 utilizes a data format 844. The database component 846 includes an implementation of a carbon dioxide offset system provider database 848. The business logic component 832 is able to access data through the data access component 840, which reads and writes data from/to the database component 846.

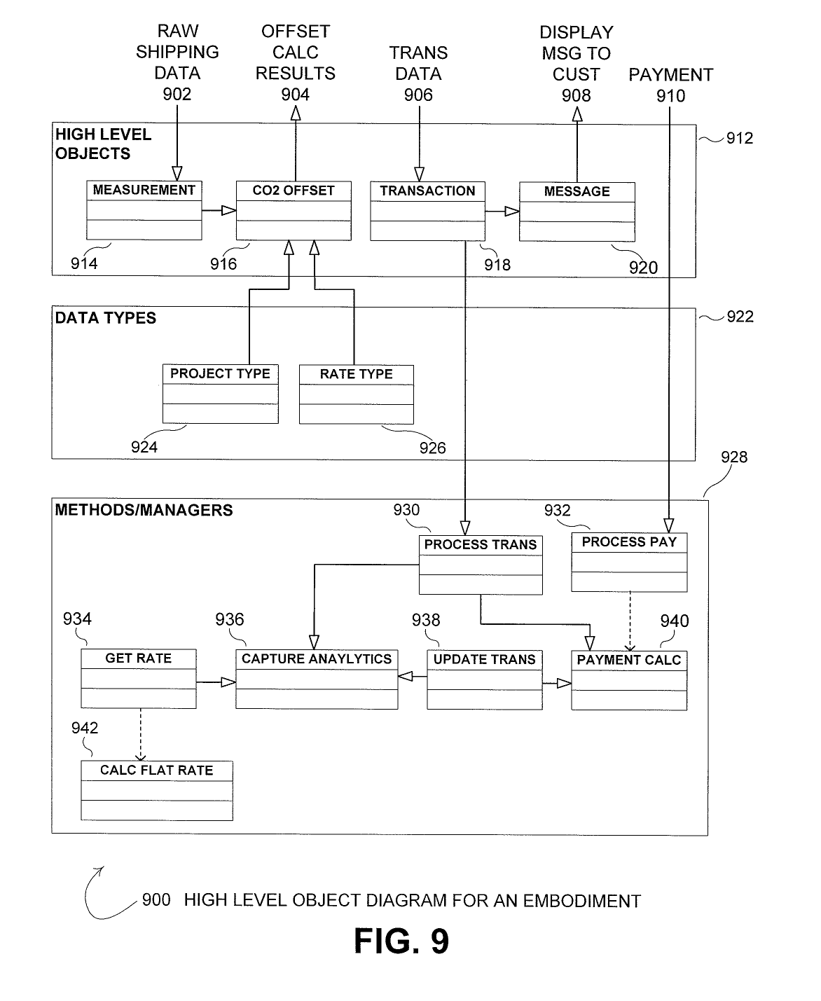

FIG. 9 is a high level object diagram 900 of software objects for an embodiment. FIG. 9 discloses a Unified Modeling Language (UML) object diagram describing the software objects for an embodiment. Software may be implemented in many different ways and the disclosure with respect to FIG. 9 is provided to illustrate how one embodiment may choose to set up the various software objects with the understanding that other embodiments may implement software objects in a different manner. The high level software object classes 912 include a measurement object class 914, a carbon dioxide offset object class 916, a transaction object class 918, and a message object class 920. A measurement object 914 receives raw shipping data 902 from a shopping cart application and delivers measurement data to a carbon dioxide offset object 916. The carbon dioxide offset object 916 includes the results of the estimated carbon dioxide emissions and cost to offset the estimated carbon dioxide emissions calculations. The carbon dioxide offset object 916 delivers the estimated carbon dioxide emissions and the cost to offset the estimated carbon dioxide emissions to the merchant shopping cart. The merchant shopping cart delivers transaction data 906 for the purchase of carbon offsets to a transaction object 918. The transaction object 916 sends data to the methods and managers 928, specifically to a process transactions method 930 to process the transaction. The transaction object 918 delivers transaction data to a message object 920. The message object 920 sends a message 908 to the merchant shopping cart for display on the merchant shopping cart.

Additional data types 922 are available to be incorporated into software objects. The carbon dioxide offset object includes the data types for project type 924 and rate type 926.

The methods/managers 928 receive information from the transaction object class 918 as well as actual payment 910 from the merchant website. The process transaction method 930 processes a transaction using transaction data 906 delivered by a transaction object 918. The process transaction method 930 delivers transaction data to the capture analytics method 936. The capture analytics method 936 records data into permanent storage. The process transaction method 930 also delivers transaction data to the payment calculation method 940. When payment 910 is received it is sent to the process payment method 932. The process payment method 932 delivers the amount of the actual payment to the payment calculation method 940 to check the payment against the expected payment information sent to the payment calculations method by the process transactions method 930. The update transaction method 938 sends updated information for a transaction to the capture analytics method 936 and the payment calculation method 940. The get rate method 934 delivers rate information to the capture analytics method 936. The get rate method 934 calculates new rates using the calculate flat rate method 942.

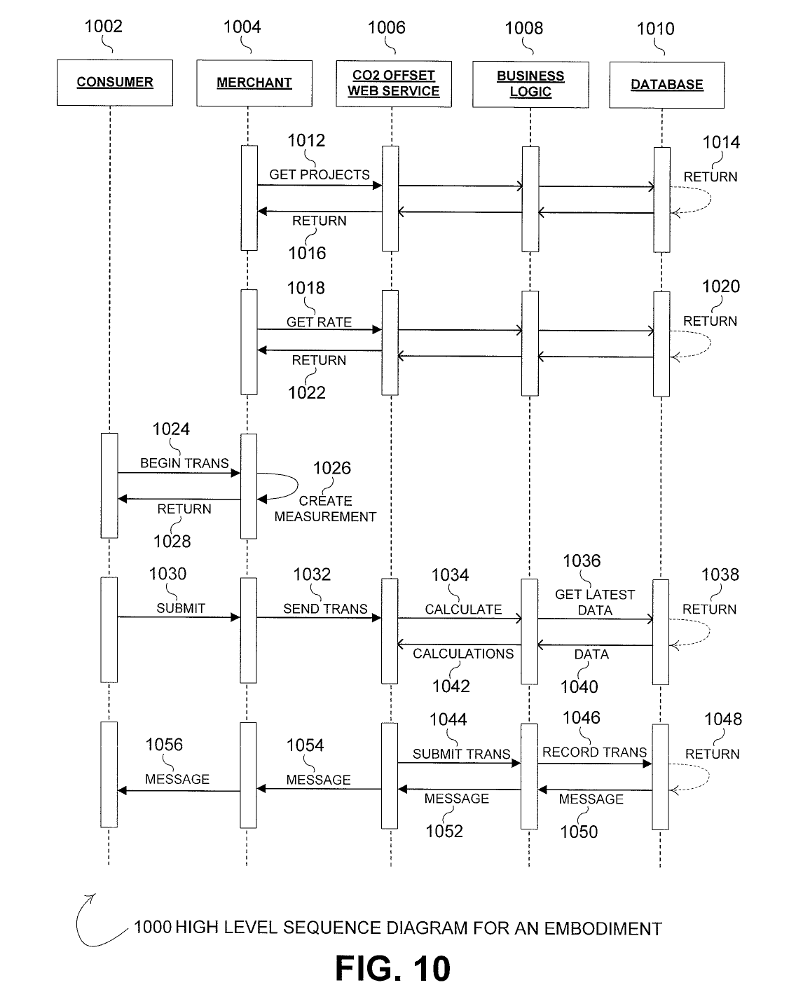

FIG. 10 is a high level sequence diagram 1000 of the sequence of operations for an embodiment. FIG. 10 discloses a Unified Modeling Language (UML) sequence diagram describing a sequence of operations for an embodiment. Software may be implemented in many different ways and the disclosure with respect to FIG. 10 is provided to illustrate how one embodiment may operate with the understanding that other embodiments may implement software operations in a different manner. There are five entities shown in the sequence diagram 1000 of FIG. 10. The five entities are the consumer 1002, the merchant 1004, the carbon dioxide offset web service 1006, the business logic 1008, and the database 1010. A merchant 1004 may initiate an action to get projects 1012 to obtain a list of all of the available carbon emission offsetting projects. The get projects request 1012 is passed from the merchant 1004 to the carbon dioxide offset web service 1006 to the business logic 1008 to the database 1010. The database locates the information and returns 1014 the list of available carbon emission offsetting projects to the merchant. The return information goes from the database 1010 to the business logic 1008 to the carbon dioxide offset web service 1006 and finally is returned 1016 to the merchant 1004.

A merchant 1004 may initiate an action to get a rate 1018 to obtain a rate to charge for carbon offsets. The get rate request 1018 is passed from the merchant 1004 to the carbon dioxide offset web service 1006 to the business logic 1008 to the database 1010. The database 1010 locates the rate information and returns 1020 the rate information to the merchant. The return information goes from the database 1010 to the business logic 1008 to the carbon dioxide offset web service 1006 and finally is returned 1022 to the merchant 1004.

A consumer 1002 may initiate an action to begin a transaction 1024. The begin transaction action 1024 is sent to the merchant 1004 and the merchant 1004 creates a measurement 1026 of the carbon offset information and returns 1028 the carbon offset information to the consumer 1002.

A consumer 1002 may submit an order 1030 to merchant 1004. The merchant 1004 sends the order transaction 1032 to the carbon dioxide offset web service 1006. The carbon dioxide web service 1006 sends a request to calculate 1034 to the business logic 1008. The business logic sends a request to get the latest data to the database 1010. The database 1010 obtains the latest data 1010 and returns 1038 the data 1040 to the business logic 1008. The business logic performs the calculations and sends the calculations 1042 to the carbon dioxide offset web service 1006.

After receiving calculations 1042, the carbon dioxide offset web service 1006 may submit a transaction 1044 to the business logic 1008. The business logic 1008 requests that the database 1010 record the transaction 1046. Once the database 1010 has recorded the transaction, the database returns 1048 by sending an acknowledgement message 1050. The message 1050 is passed to the business logic 1008 which modifies the message 1050 as necessary and sends the modified message 1052 to the carbon dioxide offset web service 1006. The carbon dioxide web service modifies the message 1052 as necessary and sends the newly modified message 1054 to the merchant 1004. The merchant 1004 modifies the message 1054 as necessary and passes the newly modified message to the consumer to view confirmation of the submitted purchase 1030.

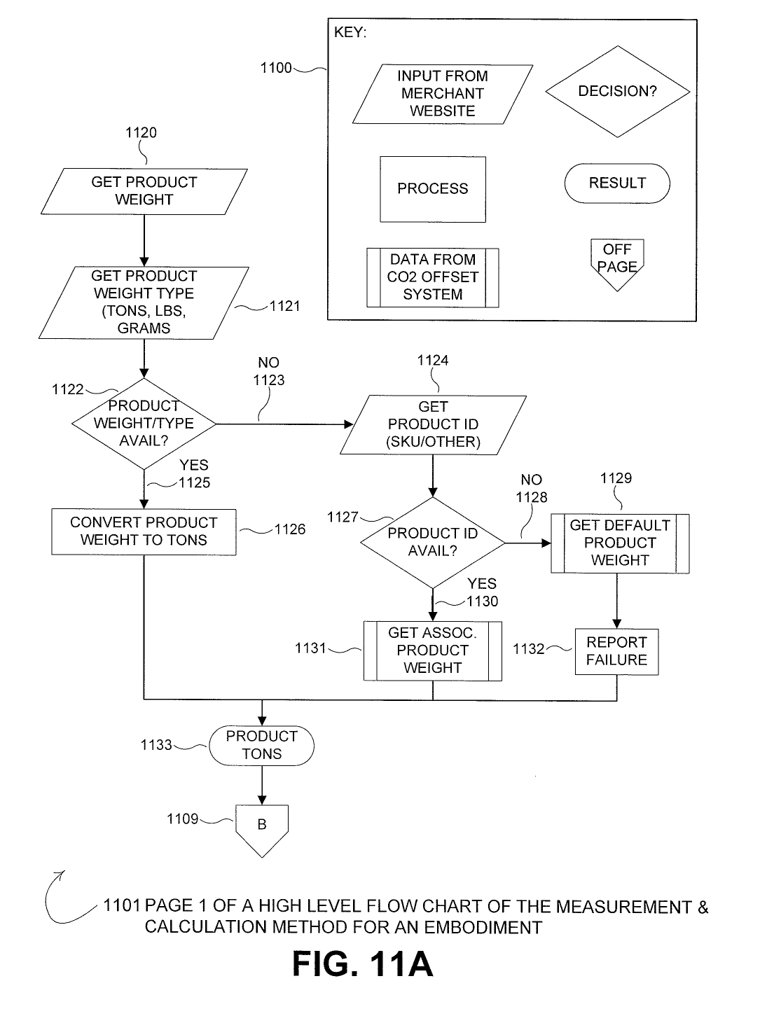

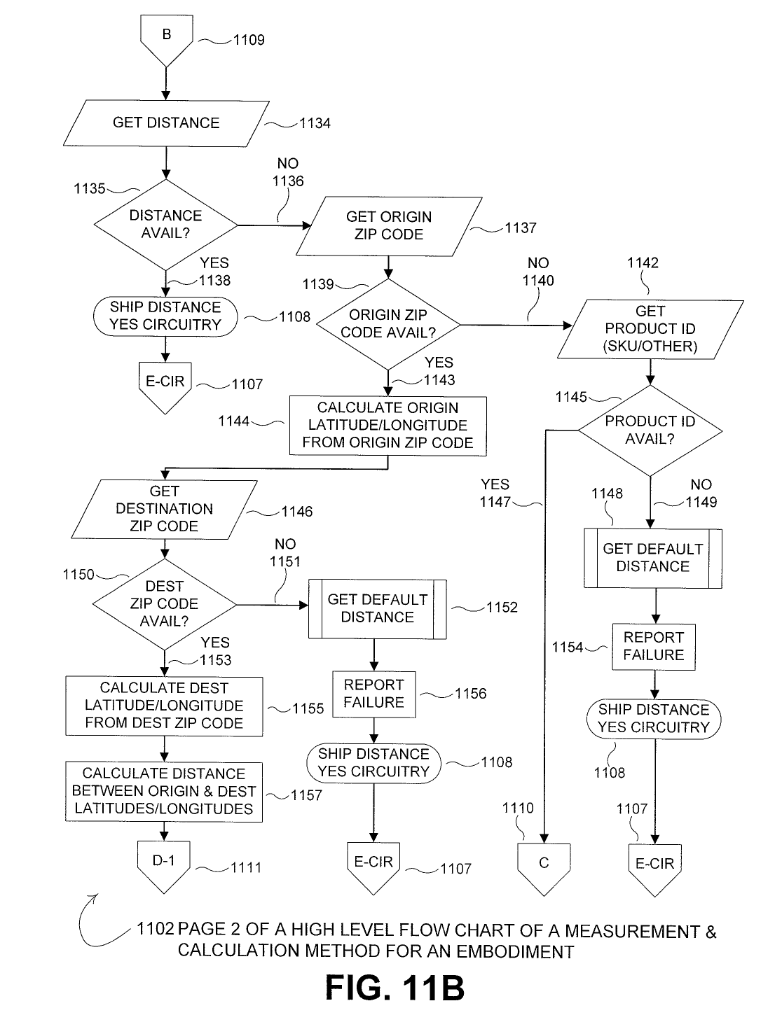

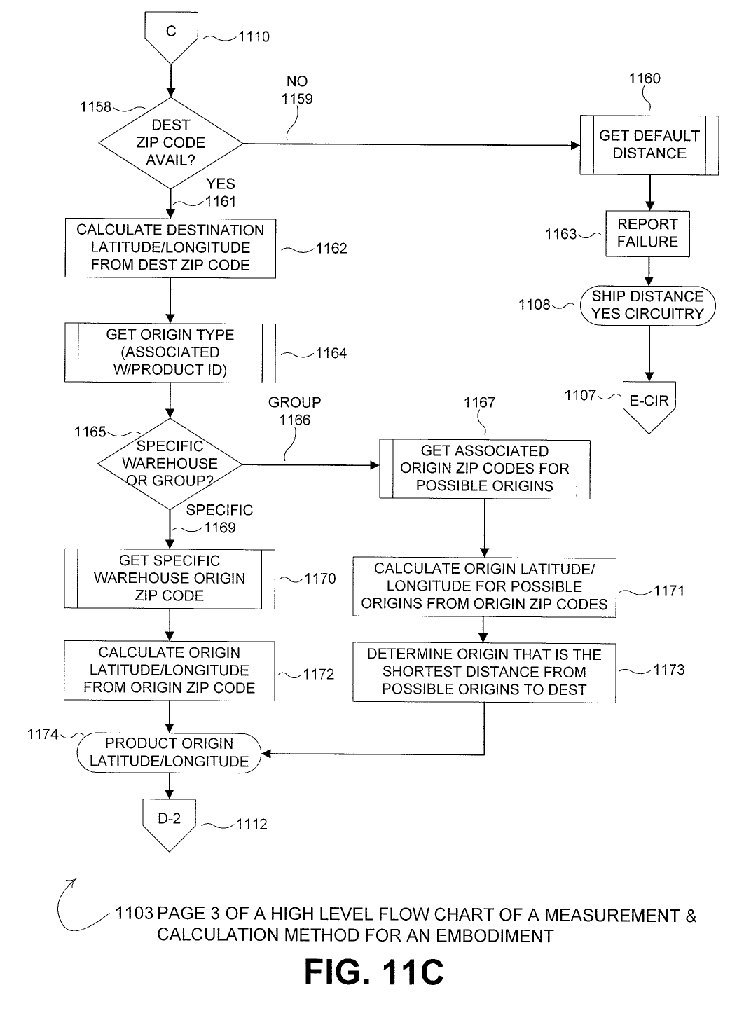

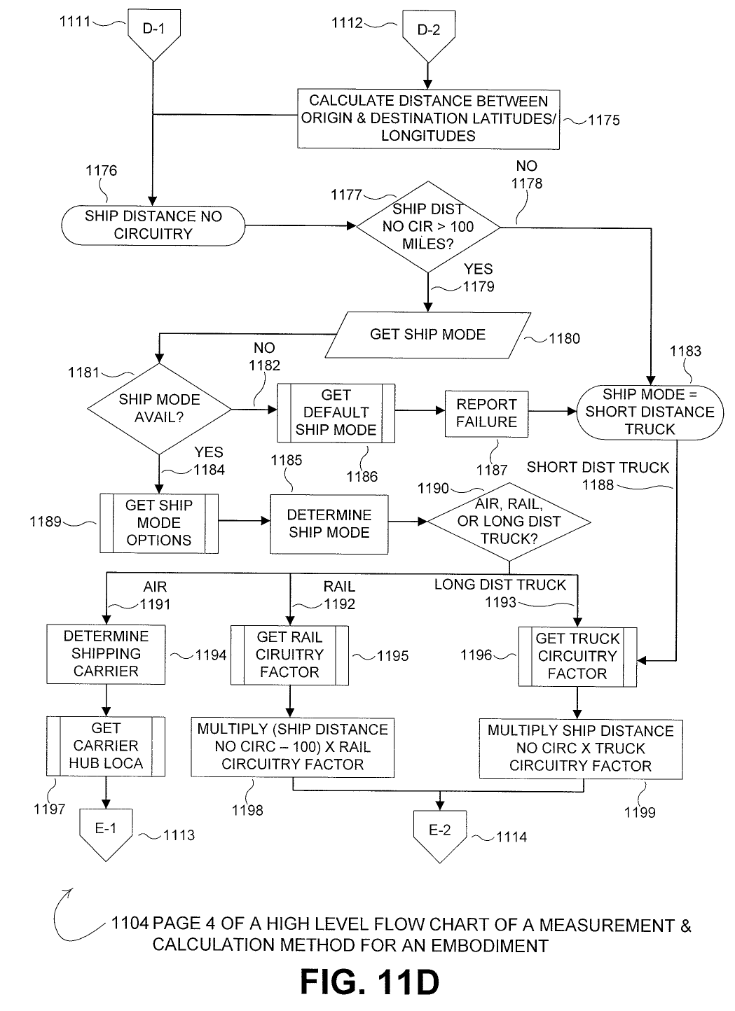

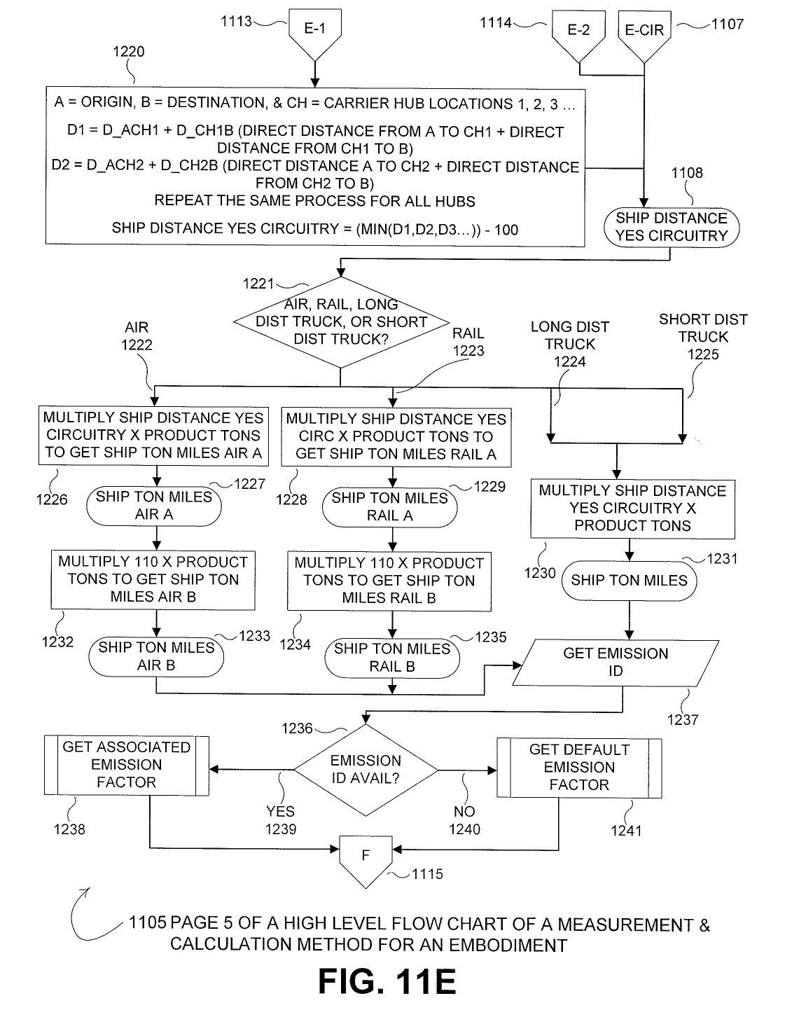

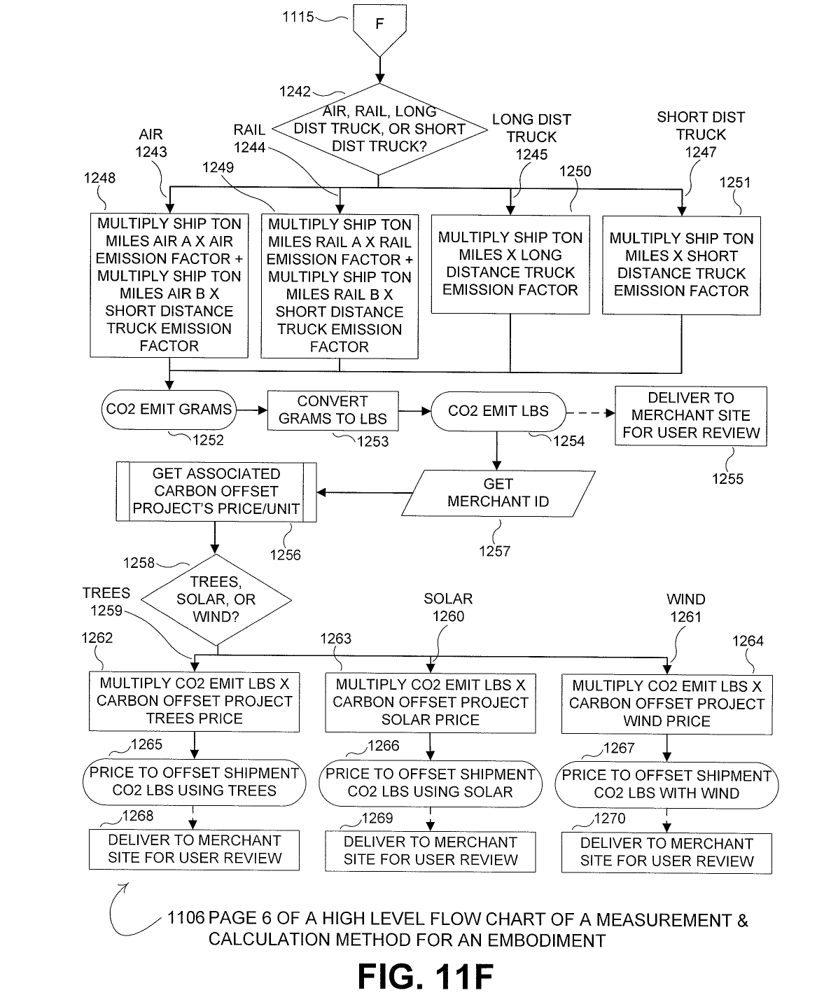

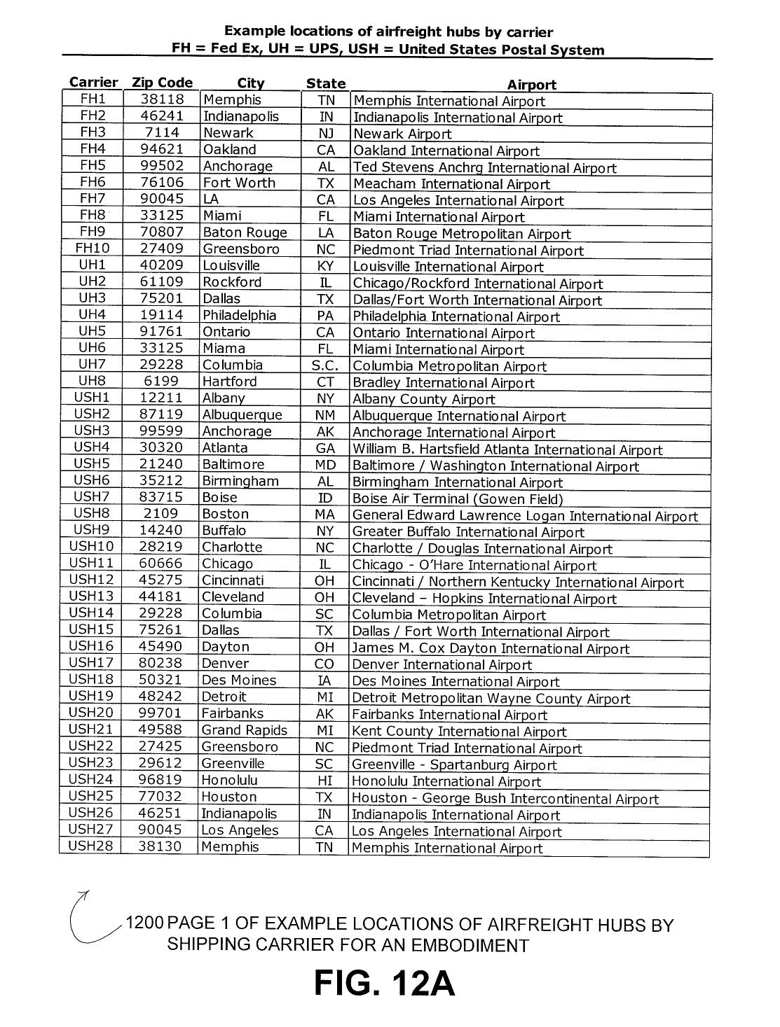

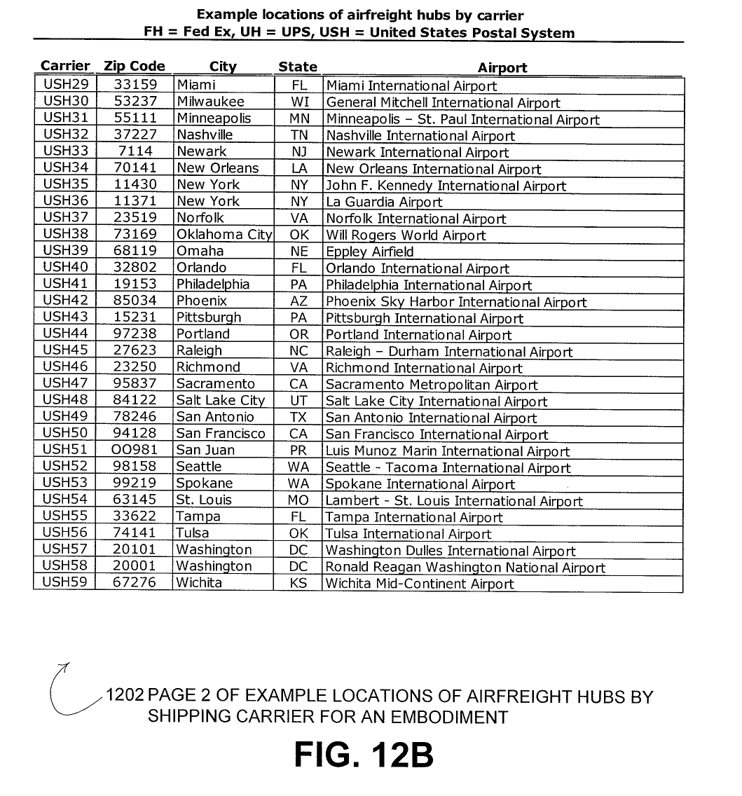

FIG. 11A-F shows a flow chart of a method that may be used by an embodiment to calculate the estimated carbon dioxide emissions and the associated monetary cost for offsetting the carbon dioxide generated by shipping a product or group of products to a consumer. The method described in FIG. 11A-F is an example of one method that may be used to perform the carbon dioxide emission calculations. Other methods with other calculations may be utilized to create a carbon dioxide offset system that estimates the carbon emissions for a specific product or group of products being shipped based on the weight of the product, the distance of shipping the product, and the transportation method for shipping the product. FIGS. 12, 13, 14 and 15 define the variables used in the example method and FIG. 11A-F defines the example method in a flow chart.

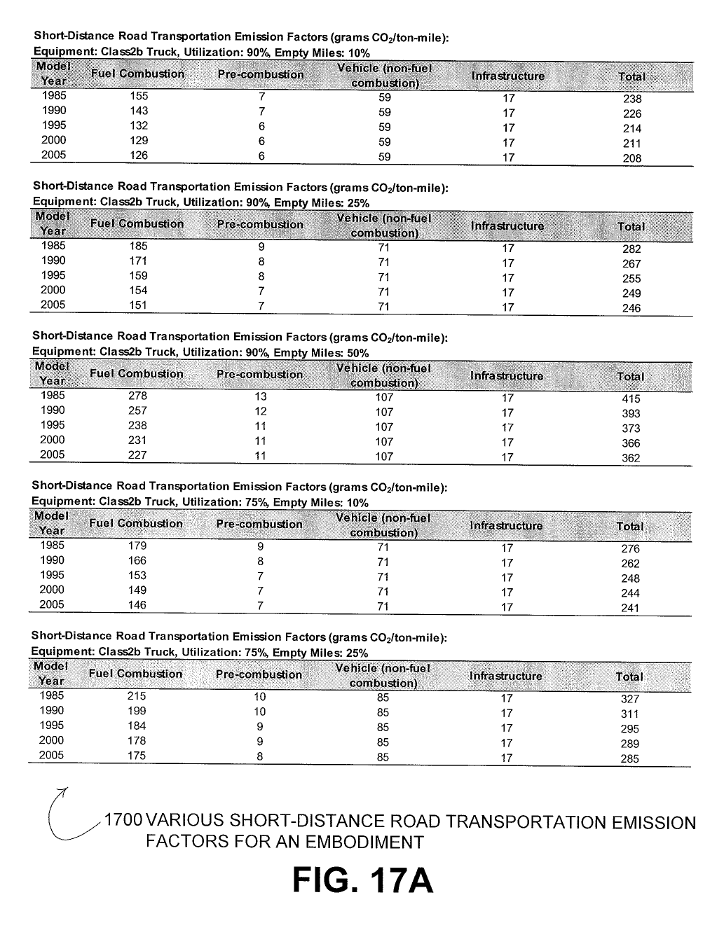

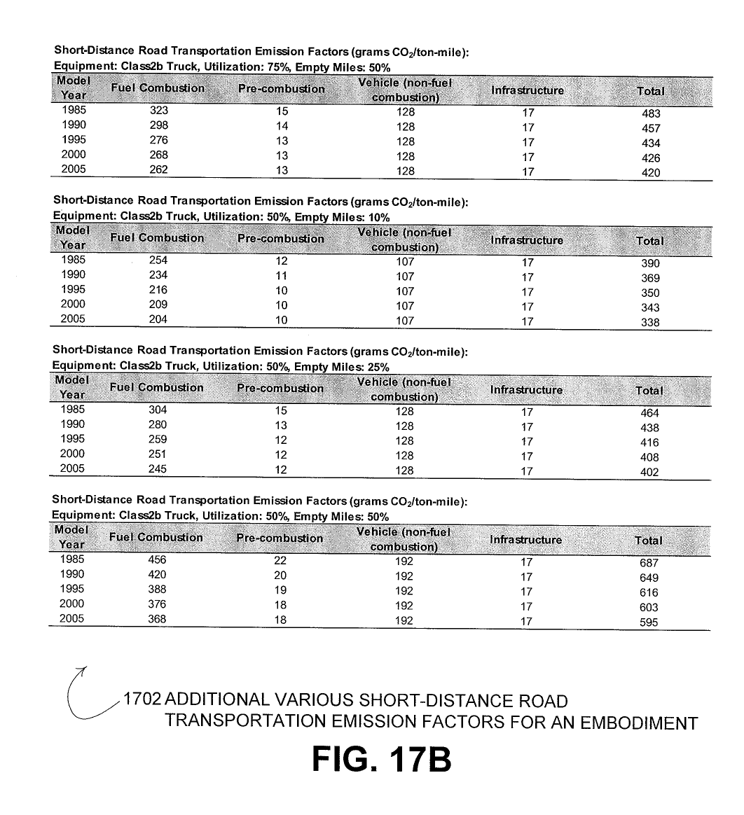

The example calculation method disclosed in FIG. 11A-F calculates carbon dioxide emissions associated with purchased products shipped from distribution centers to the customer delivery address. Domestic shipping methods included in the example method include: rail, air, and trucking. The emission factors for shipping products are provided for carbon dioxide emissions and are based on ton-miles (i.e., grams of carbon dioxide per ton-mile of freight activity). The measurement of freight activity in ton-miles is a standard practice in the shipping industry because ton-miles account for both weight and distance. In addition to the direct carbon dioxide emissions, such as fuel consumption in the vehicle, the emission factors also include indirect carbon dioxide emissions. Indirect carbon dioxide emissions are carbon dioxide emissions associated with the fuel delivery supply chain, vehicle manufacturing, and the general infrastructure. FIGS. 17-22 show tables of various emission factors for the different types of shipping transportation methods included in the example method of FIG. 11A-F. Some of the emission factors included in the tables of FIGS. 17-22 include: 1) fuel combustion emission factors for the actual combustion of fuel in the shipping vehicles; 2) pre-combustion emission factors, including oil exploration, fuel refining, and fuel distribution; 3) vehicle (non-fuel combustion) emission factors, including vehicle parts and vehicle manufacturing and assembly, vehicle maintenance, and vehicle recycling; and 4) infrastructure emission factors, including infrastructure construction, maintenance, and decommissioning. As observed in the tables shown in FIGS. 17-22, the emission factors per method of transportation are not stated as one number, but instead the emission factors are stated as several numbers along several dimensions. The emission factors were developed by Cristiano Facanha and Arpad Horvath, Department of Civil and Environmental Engineering, University of California, Berkeley. For further information please see: Facanha, C. (2006), “Life-cycle Air Emissions Inventory of Freight Transportation in the United States,” Ph.D. Dissertation, Department of Civil Engineering, University California, Berkley, and Facanha, C and Horvath, A. (2006), “Environmental Assessment of Freight Transportation in the U.S.,” International Journal of Life Cycle Assessment, 11 (4), pp. 229-239.

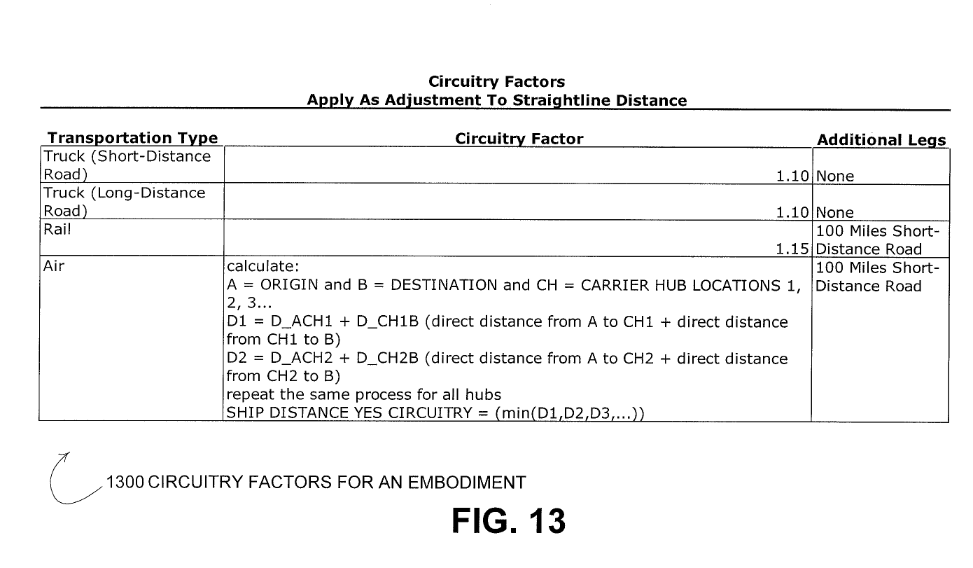

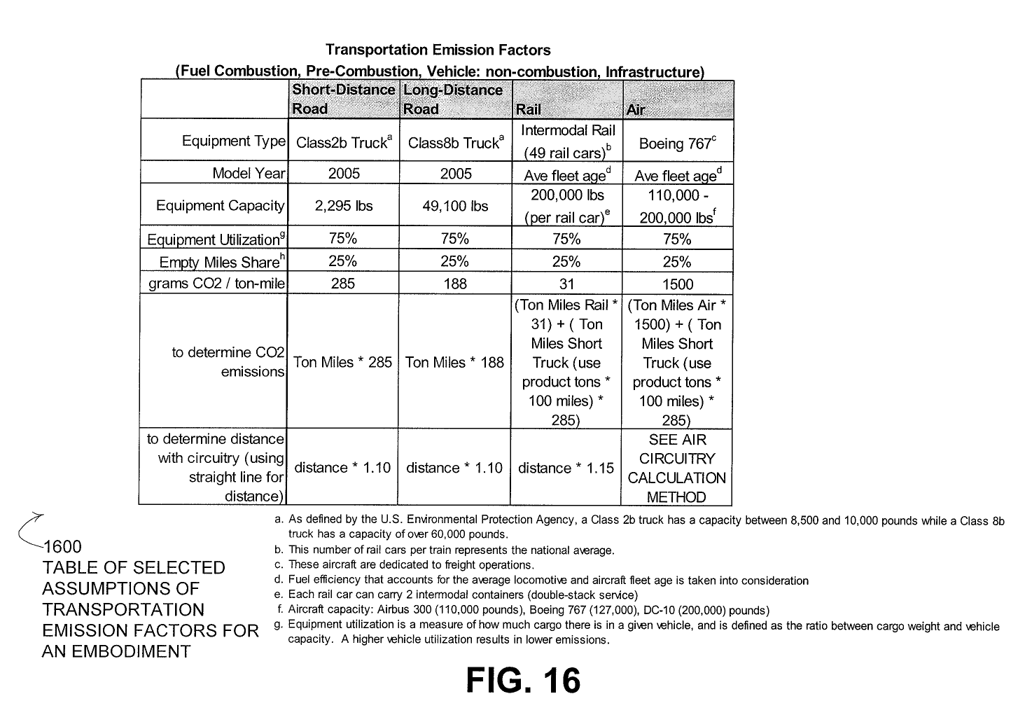

The emission factors described above are stated along several dimensions based on detailed knowledge about vehicle and carrier efficiency. In the case when a merchant is not able to report specific vehicle/carrier information during an online transaction, default vehicle/carrier information may be utilized as shown in the table of FIG. 16. In the case when a merchant is not able to report specific carrier routing information of their shipments, circuitry factors are used to adjust the shipping distance for each method of transport as shown in the table of FIG. 13. For rail and air shipments, an additional leg of a short-distance truck on both ends of the shipment may be included in the calculation as shown in the table of FIG. 13.

FIG. 11A is page 1 (1101) of a high level flow chart of a measurement and calculation method of an embodiment. A key 1100 is provided to describe the meaning of the various shapes shown in the flow chart of FIG. 11A-F. At 1120, the calculation method gets a product weight from the merchant website. At 1121, the calculation method gets the weight type (i.e., tons, pounds, grams, etc.) from the merchant website. At 1122, the calculation method determines if the weight and/or weight type is available from the merchant website. If the weight and/or weight type is available 1125, the calculation method converts the weight to tons at 1126 and stores the result of the product tons at 1133. If the product weight and/or weight type is not available 1123, then the calculation method gets the product identification (i.e., SKU or other identification system) from the merchant website at 1124. At 1127, the calculation method determines if the product identification is available from the merchant website. If the product identification is available 1130, the calculation method gets the associated product weight for the product identification from data stored on the carbon offset system at 1131. If the product identification is not available 1128, then a default product weight is obtained from data stored on the carbon offset system at 1129 and the failure is reported at 1132. From both 1131 and 1132, the calculation method stores the result of the product weight in product tons at 1133. From the product tons result 1133, the calculation moves to off-page connector B (1109) connecting to page 2 (1102) of the calculation method flow chart shown on FIG. 11B.

FIG. 11B is page 2 (1102) of a high level flow chart of a measurement and calculation method of an embodiment. Continuing from page 1 (1101) via off-page connector B (1109), the calculation method gets the distance for shipping the product or group of products at 1134. At 1135, the calculation method determines if the shipping distance is available from the merchant website. If the shipping distance is available 1138, the calculation method moves to the result “Ship Distance Yes Circuitry” at 1108 on page 5 (1105) shown in FIG. 11E via off-page connector E-CIR (1107). If the distance is not available 1136, then the calculation method gets the origin zip code at 1137. At 1139, the calculation method determines if the origin zip code is available from the merchant website. If the origin zip code is available 1143, then the calculation method calculates the origin latitude/longitude from the origin zip code at 1144 and gets the destination zip code at 1146. At 1150, the calculation method determines if the destination zip code is available from the merchant website. If the destination zip code is not available 1151, then a default distance is obtained from data stored on the carbon offset system at 1152 and the failure is reported at 1156. From 1156, the calculation method moves to the result “Ship Distance Yes Circuitry” at 1108 on page 5 (1105) shown in FIG. 11E via off-page connector E-Cir (1107). If the destination zip code is available 1153, the calculation method calculates the destination latitude/longitude from the destination zip code at 1155. At 1157, the calculation method calculates the distance between the origin and destination latitudes/longitudes and moves to page 4 (1104) of the calculation method flow chart via off-page connector D-1 (1111) which connects to the result “Ship Distance No Circuitry” 1176 shown on FIG. 11D.

If, at 1139, the origin zip code is not available from the website 1140, then the calculation method gets the product identification (i.e., SKU or other identification system) from the merchant website at 1142. At 1145, the calculation method determines if the product identification is available from the merchant website. If the product identification is not available 1149, then a default distance is obtained from data stored on the carbon offset system at 1148 and the failure is reported at 1154. From 1154, the calculation method moves to the result “Ship Distance Yes Circuitry” at 1108 on page 5 (1105) shown in FIG. 11E via off-page connector E-Cir (1107). If the product identification is available 1147, the calculation method moves to page 3 (1103) of the flow chart describing the calculation method shown in FIG. 11C via off-page connector C (1110).

FIG. 11C is page 3 (1103) of a high level flow chart of a measurement and calculation method of an embodiment. Continuing from page 2 (1102) via off-page connector C (1110), the calculation method determines if the destination zip code is available from the merchant website at 1158. If the destination zip code is not available 1159, then a default distance is obtained from data stored on the carbon offset system at 1160 and the failure is reported at 1163. From 1163, the calculation method moves to the result “Ship Distance Yes Circuitry” at 1108 on page 5 (1105) shown in FIG. 11E via off-page connector E-Cir (1107). If the destination zip code is available 1161, then the calculation method calculates the destination latitude/longitude from the destination zip code at 1162. At 1164, the calculation method gets the origin type associated with the product identification from data stored on the carbon offset system. At 1165, the calculation method determines whether the origin for shipping is from a specific warehouse or from a group of potential warehouses. If the origin is from a group of potential warehouses 1166, the calculation method gets the associated origin zip codes for the possible origins from data stored on the carbon offset system at 1167. At 1171, the calculation method calculates the origin latitude/longitude for all of the possible origin zip codes of the potential origin warehouses. At 1173, the calculation method determines the origin that is the shortest distance from the possible origins to the destination and stores the result origin as the product origin latitude/longitude at 1174. If the origin is a specific warehouse 1169, then the calculation method gets the zip code of the specific warehouse from data stored on the carbon offset system at 1170. At 1172, the calculation method calculates the origin latitude/longitude from the origin zip code and stores the product origin latitude/longitude at 1174. From 1174, the calculation method moves to page 4 (1104) of the calculation method flow chart shown in FIG. 11D via off-page connector D-2 (1112).

FIG. 11D is page 4 (1104) of a high level flow chart of a measurement and calculation method of an embodiment. Continuing from page 2 (1102) via off-page connector D-1 (1111), the calculation method moves directly to the result “Ship Distance No Circuitry” at 1176. Continuing from page 3 (1103) via off-page connector D-2 (1112), the calculation method calculates the distance between the origin and destination latitudes/longitudes at 1175. From 1175, the calculation method moves to the result “Ship Distance No Circuitry” at 1176. At 1177, the calculation method determines if the ship distance with no circuitry is greater than 100 miles. If the ship distance with no circuitry is not greater than 100 miles (1178), then, at 1183, the ship mode is set equal to short distance truck 1188. If the ship distance with no circuitry is greater than 100 miles (1179), then the calculation method gets the ship mode from the merchant website at 1180. At 1181, the calculation method determines if the ship mode is available from the merchant website. If the ship mode is not available 1182, the calculation method gets a default ship mode from the carbon offset system at 1186 and reports the failure at 1187. At 1183, the calculation method sets the ship mode equal to short distance truck 1188. If, at 1181, the ship mode is available 1184, then the calculation method gets the ship mode options from data stored on the carbon offset system at 1189. At 1185, the calculation method determines the ship mode. At 1190, the calculation method determines if the ship mode is by air, by rail, or by long distance truck. If the ship mode is by air 1191, then the calculation method determines the shipping carrier at 1194 and gets the carrier hub locations from data stored on the carbon offset system at 1197. FIG. 12A-B shows a table of example hub locations by shipping carrier. From 1197 the calculation method moves to page 5 (1105) of the flow chart of the calculation method shown in FIG. 11E via off-page connector E-1 (1113). If the ship mode is by rail 1192, then the calculation method determines the rail circuitry factor at 1195 and multiplies the ship distance with no circuitry (minus 100 miles) times the rail circuitry factor at 1198. From 1198, the calculation method moves to page 5 (1105) of the flow chart of the calculation method shown in FIG. 11E via off-page connector E-2 (1114). If the ship mode is by long distance truck 1193, or if the ship mode is by short distance truck 1188, then the calculation method gets the truck circuitry factor from the carbon offset system at 1196 and multiplies the ship distance with no circuitry times the truck circuitry factor at 1199. From 1199, the calculation method moves to page 5 (1105) of the flow chart of the calculation method shown in FIG. 11E via off-page connector E-2 (1114).

FIG. 11E is page 5 (1105) of a high level flow chart of a measurement and calculation method of an embodiment. Continuing from page 4 (1104) via off-page connector E-2 (1114) and various other pages via off-page connector E-CIR (1107), the calculation method moves directly to the result “Ship Distance Yes Circuitry” at 1108. Continuing from page 4 (1104) via off-page connector E-1 (1113), the calculation method calculates the shortest distance between the origin and the destination via an intervening hub for air ship modes at 1220. To calculate the shortest distance from the origin to the destination via a hub, the calculation method calculates the distance from the origin to the hub plus the distance from the hub to the destination for each potential hub. The calculation method then selects the minimum distance from the calculated distance for each hub. From the calculation of the shortest distance between the origin and the destination via an intervening hub for air ship modes at 1220, the calculation method moves to the result “Ship Distance Yes Circuitry” at 1108. From 1108, the calculation method determines whether the ship mode is by air, by rail, by long distance truck, or by short distance truck at 1221. If the ship mode is by air 1222, the calculation method multiplies the ship distance with circuitry times the product tons to get ship ton miles by air A at 1226 and stores the ship ton miles by air A at 1227. At 1232, the calculation method multiplies the product tons by 110 to get ship ton miles by air B and stores the ship ton miles by air B at 1233. The example method uses an adjustment of 110 miles as a default short distance truck mileage addition to the distance for air shipping to account for the shipping from the warehouse to the airport and from the airport to the destination along with a circuitry factor applied to that distance. Other adjustment values may be utilized in other embodiments, but distances of roughly 110 miles are the average additional miles for typical air shipping modes. Some embodiments may calculate the actual mileage from the origin to the airport and from the airport to the destination. If the ship mode is by rail 1223, the calculation method multiplies the ship distance with circuitry times the product tons to get ship ton miles by rail A at 1228 and stores the ship ton miles by rail A at 1229. At 1234, the calculation method multiplies the product tons by 110 to get ship ton miles by rail B and stores the ship ton miles by rail B at 1234. The example method uses an adjustment of 110 miles as a default short distance truck mileage addition to the distance for rail shipping to account for the shipping from the warehouse to the railroad and from the railroad to the destination along with a circuitry factor applied to that distance. Other adjustment values may be utilized in other embodiments, but distances of roughly 110 miles are the average additional miles for typical rail shipping modes. Some embodiments may calculate the actual mileage from the origin to the railroad and from the railroad to the destination. If the ship mode is long distance truck 1224 or short distance truck 1225, the calculation method multiplies the ship distance with circuitry times the product tons at 1230 and stores the ship ton miles at 1231. From ship ton miles results 1233, 1235, and 1231, the calculation moves to 1237 and gets an emission identification from the merchant website. At 1236, the calculation method determines if the emission identification is available from the merchant website. If the emission identification is available 1239, the calculation method gets the associated emission factor from data stored on the carbon offset system at 1238 and moves to page 6 (1206) of the flow chart of the calculation method shown in FIG. 11F via off-page connector F (1115). If the emission identification is not available 1240, the calculation method gets a default emission factor from data stored on the carbon offset system at 1241 and moves to page 6 (1206) of the flow chart of the calculation method shown in FIG. 11F via off-page connector F (1115).

FIG. 11F is page 6 (1106) of a high level flow chart of a measurement and calculation method of an embodiment. Continuing from page 5 (1105) via off-page connector F (1115), the calculation method determines if the ship mode is by air, by rail, by long distance truck, or by short distance truck at 1242. If the ship mode is by air 1243, the calculation method multiplies ship ton miles air A (1227) by air emission factor and adds the product of ship ton miles air B (1233) times short distance truck emission factor at 1248 to obtain the emitted grams of carbon dioxide stored at result “CO2 Emit Grams” 1252. If the ship mode is by rail 1244, the calculation method multiplies ship ton miles rail A (1229) by rail emission factor and adds the product of ship ton miles rail B (1235) times short distance truck emission factor at 1249 to obtain the emitted grams of carbon dioxide stored at result “CO2 Emit Grams” 1252. If the ship mode is by long distance truck 1245, the calculation method multiplies ship ton miles (1231) by long distance truck emission factor at 1250 to obtain the emitted grams of carbon dioxide stored at result “CO2 Emit Grams” 1252. If the ship mode is by short distance truck 1247, the calculation method multiplies ship ton miles (1231) by short distance truck emission factor at 1251 to obtain the emitted grams of carbon dioxide stored at result “CO2 Emit Grams” 1252. From the “CO2 Emit Grams” result 1252, the calculation method converts the emission grams to pounds at 1253 and stores the resultant “CO2 Emit Pounds” at 1254. The calculation method may report the carbon dioxide emissions in pounds to the merchant website for user review at 1255. From 1254, the calculation method gets a merchant identification from the merchant website at 1257. At 1256, the calculation method gets the carbon offset project's price per unit associated with the merchant identification from 1257. At 1258, the calculation method determines whether the carbon offset project is for trees, solar energy, or wind energy. If the carbon offset project is for trees 1259, the calculation method multiplies the “CO2 Emit Pounds” 1254 times the carbon offset project trees price at 1262 and stores the price to offset the shipment carbon dioxide pounds using trees result at 1265. The calculation method may then deliver the carbon dioxide offset price 1265 to the merchant site for user review at 1268. If the carbon offset project is for solar energy 1260, the calculation method multiplies the “CO2 Emit Pounds” 1254 times the carbon offset project solar energy price at 1263 and stores the price to offset the shipment carbon dioxide pounds using solar energy result at 1266. The calculation method may then deliver the carbon dioxide offset price 1266 to the merchant site for user review at 1269. If the carbon offset project is for wind energy 1261, the calculation method multiplies the “CO2 Emit Pounds” 1254 times the carbon offset project wind energy price at 1264 and stores the price to offset the shipment carbon dioxide pounds using wind result at 1267. The calculation method may then deliver the carbon dioxide offset price 1267 to the merchant site for user review at 1270.

The flow chart of FIG. 11A-F describes a calculation method in great detail. Various embodiments may implement the calculation method in a variety of manners where the product weight, ship distance, and transportation method (i.e., shipping mode) are taken into account during the calculation of the estimated carbon dioxide emissions.

FIG. 12A is page 1 (1200) of a table of example locations of airfreight hubs by shipping carrier for an embodiment. The table 1200 of locations of airfreight hubs may be utilized for the calculations at 1220 on page 5 (1105) shown in FIG. 11E of the flow chart for the calculation method disclosed with respect to FIG. 11A-F.

FIG. 12B is page 2 (1202) of a table of example locations of airfreight hubs by shipping carrier for an embodiment.

FIG. 13 is a table 1300 of circuitry factors for an embodiment. The circuitry factors may be utilized in the calculations of 1198 and 1199 of page 4 (1104) shown in FIG. 11D and in the calculation of 1220 of page 5 (1105) shown in FIG. 11E of the flow chart for the calculation method disclosed with respect to FIG. 11A-F. The table of circuitry factors 1300 also shows where additional legs of transportation may be expected.

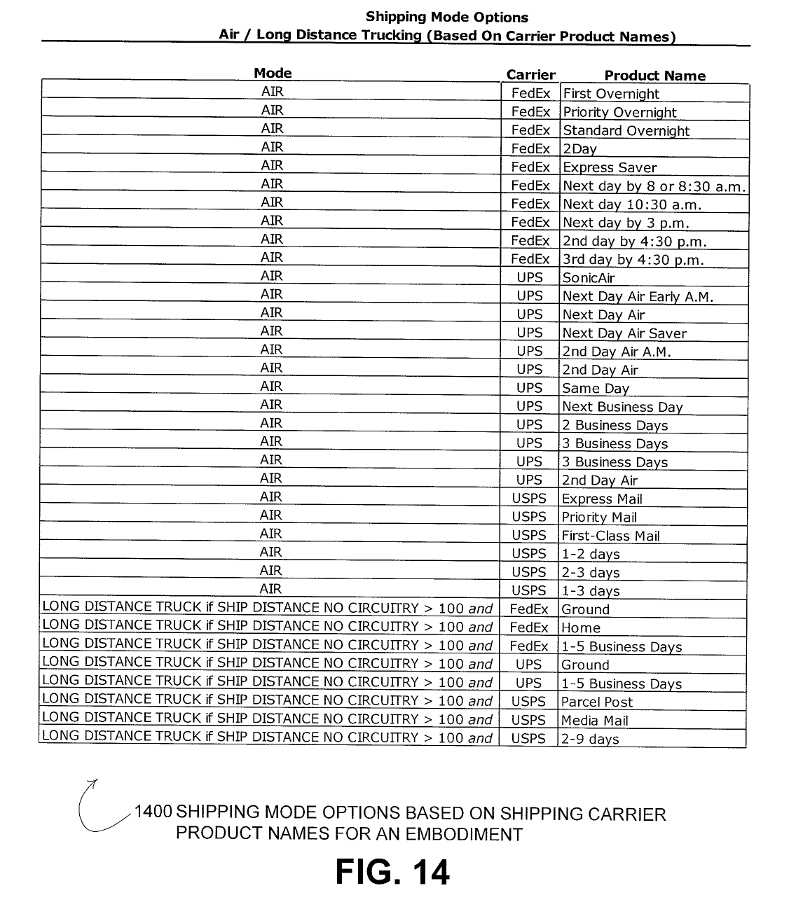

FIG. 14 is a table 1400 of shipping mode options based on carrier product names for an embodiment. The shipping mode may be utilized in determination of shipping mode at 1185 of page 4 (1104) shown in FIG. 11D of the flow chart for the calculation method disclosed with respect to FIG. 11A-F.

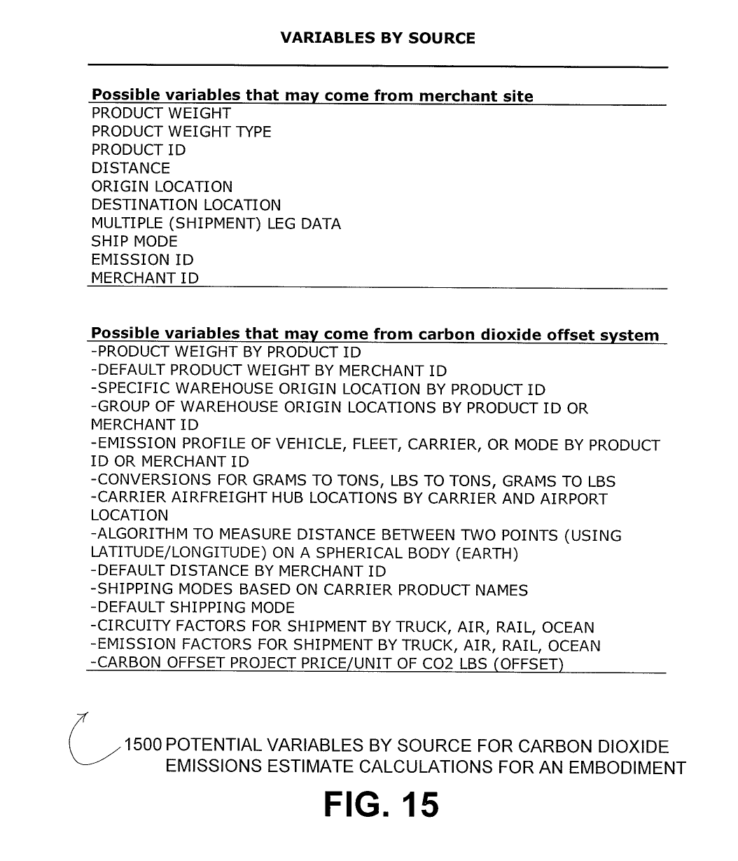

FIG. 15 is a table 1500 of potential variables by source (merchant or offset system) for carbon dioxide emissions estimate calculation method disclosed with respect to FIG. 11A-F for an embodiment.

FIG. 16 is a table 1600 of selected assumptions of transportation emission factors used as a default for an embodiment. Unlike the specific emission factors shown in the tables of FIGS. 17-22, the table 1600 of FIG. 16 makes some assumptions about circuitry, equipment utilization, empty miles, and model year of vehicles that are not assumed in the tables of FIGS. 17-22. The assumptions of table 1600 were made to accommodate real world situations where a merchant is not able to supply specific shipping emission data of their own vehicles, or their shipping carrier's vehicles, and/or is not able to match with an entry in the tables of FIGS. 17-22. When merchants are able to share more detailed information about a proposed product shipment, then the calculations may use the specific values provided by the merchant or as available in the tables of FIGS. 17-22. The assumptions shown in table 1600 are representative of one embodiment. Other embodiments may make other assumptions, and assumptions may be updated, added, and/or modified as information provided by shipping companies is updated or changed.

FIG. 17A is tables 1700 of various short-distance road transportation emission factors for an embodiment.

FIG. 17B is additional tables 1702 of various short-distance road transportation emission factors for an embodiment.

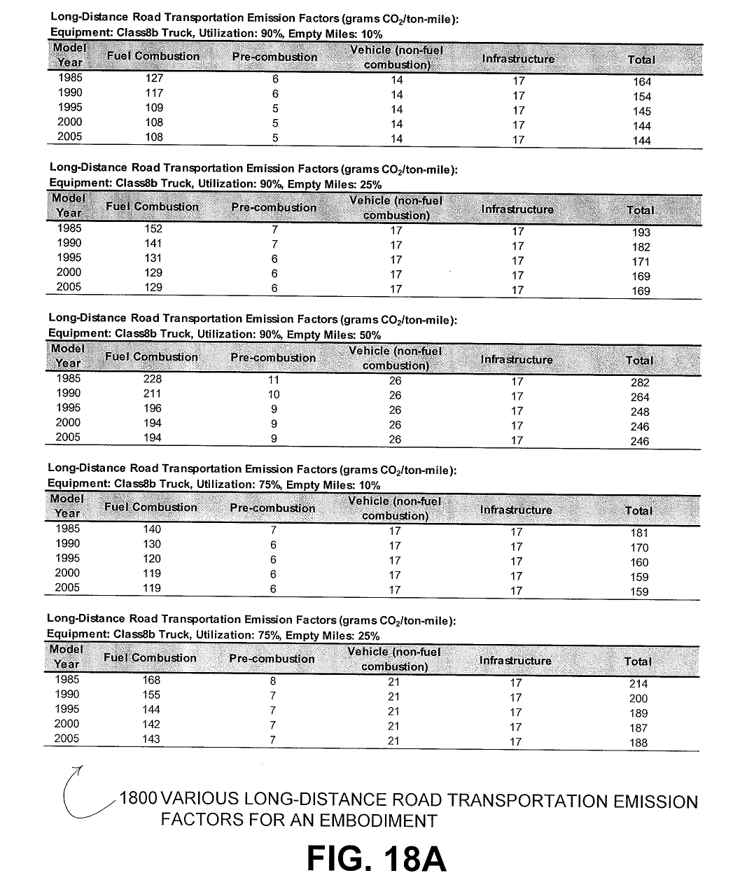

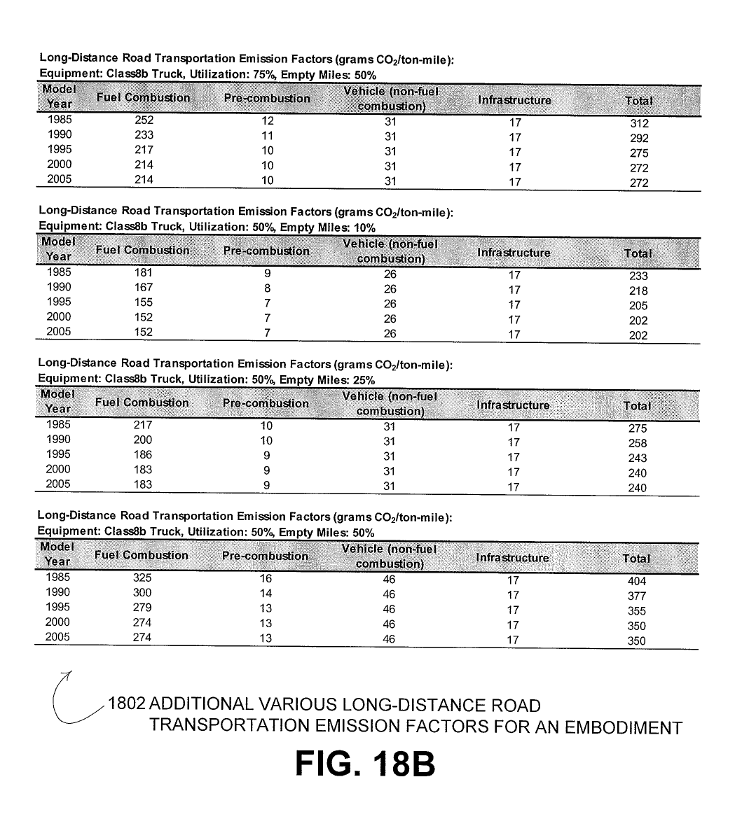

FIG. 18A is tables 1800 of various long-distance road transportation emission factors for an embodiment.

FIG. 18B is additional tables 1802 of various long-distance road transportation emission factors for an embodiment.

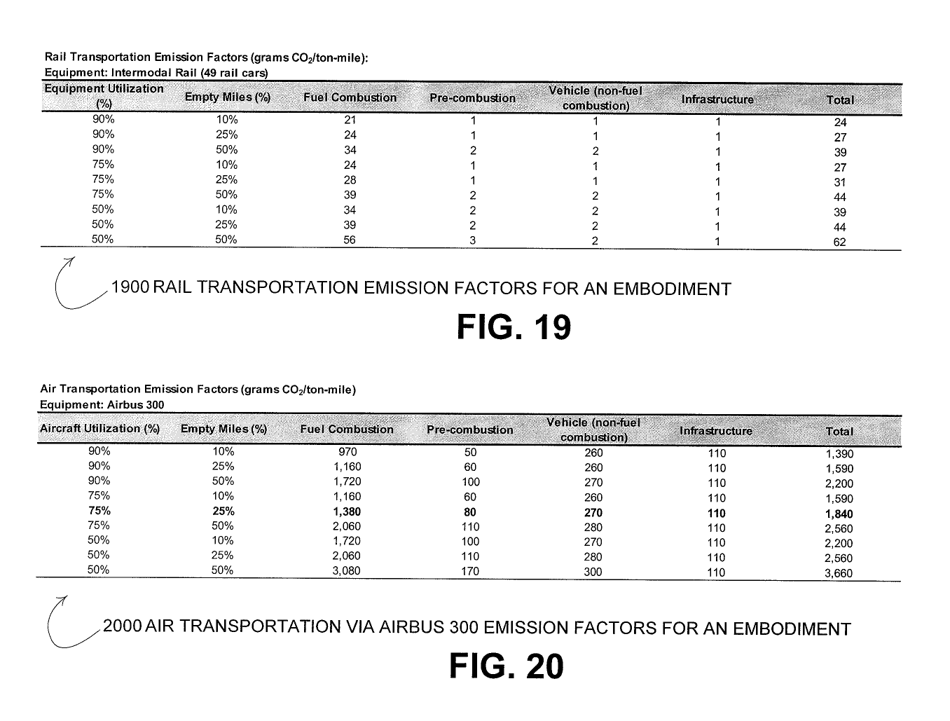

FIG. 19 is a table 1900 of rail transportation emission factors for an embodiment.

FIG. 20 is a table 2000 of air transportation via an Airbus 300 airplane emission factors for an embodiment.

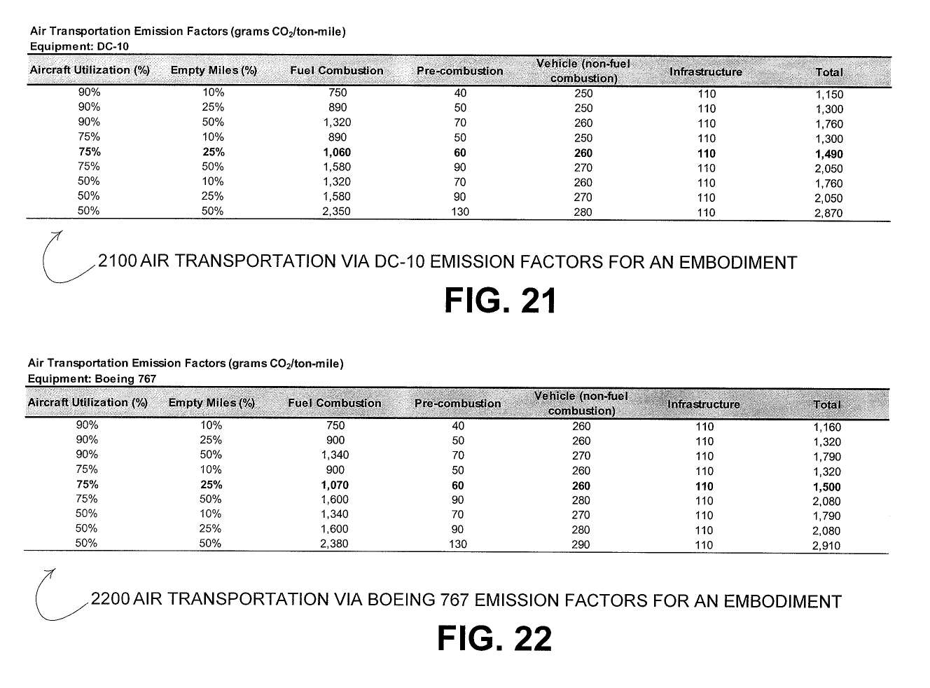

FIG. 21 is a table 2100 of air transportation via a DC-10 airplane emission factors for an embodiment.

FIG. 22 is a table 2200 of air transportation via a Boeing 767 airplane emission factors for an embodiment.

FIGS. 17-22 disclose tables of emission factors for various transportation methods for an embodiment. Other embodiments may employ different emission factors than the specific emission factors shown in the tables of FIGS. 17-22.

Various embodiments may therefore address greenhouse gases generated by the shipment of purchased products to customers. Various embodiments may provide a flexible and scalable platform that combines best science practices and carbon dioxide offset projects with sophisticated reporting and analytics. Various embodiments may further provide a simple carbon dioxide offset shipping system that is easy for online merchants to integrate into existing enterprise and non-enterprise shopping cart systems and e-commerce applications. Various embodiments may also be designed to allow for varying data supplied by shippers while striving for the most accurate carbon dioxide emissions and cost calculations available.

A merchant that includes a carbon dioxide offset system on the merchant website may experience enhanced public relations and advertising exposure to the general public. By “going green” with a carbon dioxide offset system, a merchant may attract new customers and gain loyalty from existing customers who appreciate the merchant's proactive approach to mitigating carbon generated by the merchant in the course of doing business. Further, a merchant may also share in the revenue stream coming from customers purchasing carbon dioxide offsets. Additionally, as governments attempt to address global warming issues, it may become a mandate for merchants to include the purchase of carbon offsets for shipping, thus, necessitating the use of an embodiment.

For the majority of the embodiments disclosed, carbon dioxide is considered the emissions that are being offset. While carbon dioxide is considered the largest contributor to man-made climate change, other Greenhouse Gases may also be considered in an embodiment when calculating emissions. In some cases, a Carbon Dioxide Equivalent (CO2e) may be used to account for the effect of other Greenhouse Gases. A CO2e measures the global warming potential of a particular Greenhouse Gas compared to the effect of carbon dioxide on global warming. For example, one unit of a Greenhouse Gas with a CO2e of 21 would have the warning effect of 21 units of carbon dioxide emissions over time (typically measured over a time frame of 100 years). The Greenhouse Gases (GHGs) covered under the Kyoto Protocol include: CO₂, CH₄, N₂O, HFCs, PFCs, and SF₆. Other gases may also be considered Greenhouse Gases for an embodiment by some parties even though they are not currently included in the Kyoto Protocol as a Greenhouse Gas. The United Nations Framework Convention on Climate Change (UNFCCC) is a treaty aimed at stabilizing Greenhouse Gas concentrations in the atmosphere. Carbon offset projects may or may not be accredited under the UNFCCC. Once a carbon offset project is accredited by the UNFCCC, the carbon offset project may be used as a carbon credit and linked with official emission trading schemes, such as: the European Union Emission Trading Scheme, the Kyoto Protocol, and/or as Certified Emission Reductions (CERs). Some additional types of “carbon credits” include, but are not limited to: European Union Allowances (EUAs), Assigned Amount Units (AAUs), Emission Reduction Units (ERUs), Temporary Certified Emission Reductions (tCERs), and Pre-registered Emission Reductions (pre-CERs). Embodiments may fund one or multiple types of “carbon offsets” and/or “carbon credits” for funding of the carbon offsetting application. Carbon offsets may not be certified under the UNFCCC, but still may provide valuable carbon offsets in the struggle to reduce overall man-made emissions. Other entities than those associated with the UNFCCC may verify the accuracy of the amount of emissions offset by a “carbon offset.” Some types of “carbon offsets” include, but are not limited to: Verified or Voluntary Emissions Reductions (VERs) and Renewable Energy Credits (RECs). Additional types of carbon offset/carbon credit schemes may currently be available or may become available. Various embodiments may utilize the additional types of carbon offsets/carbon credits in a similar fashion as for funding of the various types of carbon offsetting applications specifically disclosed herein.

Many of the embodiments disclosed assume that the merchant website will be the party working with the carbon dioxide offset system. Another embodiment may work with the shipping carrier such that the shipping carrier provides a new product, for instance “ship green” such that the new product incorporates the calculations of an embodiment, but is priced as part of the shipping cost for the end customer through the shipping carrier rather than as an addition to the product cost through the merchant website.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method to offset carbon emissions generated by shipping at least one product purchased via interaction with a web enabled network system comprising:
providing said web enabled network system;
providing at least one customer interacting with said web enabled network system;
providing at least one merchant website operated by at least one merchant on said web enabled network system, said merchant website having a shopping cart subsystem that provides a purchasing interface for said at least one customer to purchase said at least one product and to define shipping instructions to ship said at least one product;
providing a central computer system that has computer readable storage media for storing software programs and other data utilized during operation of said software programs;
running an application server program on said central computer system;
providing a carbon offset subsystem by said application server program to said shopping cart subsystem of said at least one merchant website;
receiving by said carbon offset subsystem shipping information about said at least one product being purchased by said at least one customer from said shopping cart subsystem of said merchant website, said shipping information being at least a weight of said at least one product, distance information that defines a distance that said at least one product is shipped, and a transportation method for shipping of said at least one product;
calculating by said carbon offset subsystem an estimated amount of carbon emissions generated from shipping said at least one product such that said calculation of said estimated amount of carbon emissions is based on said weight of said at least one product, said distance information that defines said distance that said at least one product is shipped, and said transportation method for shipping said at least one product of said shipping information;
calculating by said carbon offset subsystem an estimated cost to offset said calculated estimated amount of carbon emissions generated from shipping said at least one product;
delivering said estimated cost to offset said estimated amount of carbon emissions generated from shipping said at least one product from said carbon offset subsystem to said shopping cart subsystem such that said shopping cart subsystem includes said estimated cost to offset said estimated carbon emissions in a total cost to purchase and ship said at least one product;
receiving at least a portion of said estimated cost to offset said estimated amount of carbon emissions generated from shipping said at least one product from said at least one merchant after said at least one product has been purchased by said at least one customer; and
delivering at least a sub-portion of said portion of said estimated cost to offset said estimated amount of carbon emissions generated from shipping said at least one product to an entity implementing a carbon offsetting application.

2. The method of claim 1 wherein said distance information comprises at least one of the group comprising: a distance that said at least one product is to be shipped, an origination location where said at least one product is shipped from, a destination to ship said at least one product, a warehouse where said at least one product is to ship from, a list of warehouses where said at least one product may ship from, a default distance based product identification string, and a default distance.

3. The method of claim 1 wherein said shipping information additionally comprises at least one of the group comprising: product weight type, product identification, multiple leg data, multiple shipment data, emission identification, and merchant identification.

4. The method of claim 1 further comprising delivering a second sub-portion of said portion of said estimated cost to offset said estimated amount of carbon emissions generated from shipping said at least one product to a second entity that manages operation of said method to offset carbon emissions generated by shipping at least one product purchased via interaction with a web enabled network system.

5. The method of claim 1 further comprising:
allocating said sub-portion of said portion of said estimated cost to offset said estimated amount of carbon emissions generated from shipping said at least one product to said entity implementing said carbon offsetting application;
consolidating a plurality of sub-portions allocated to said entity implementing said carbon offsetting application into a single bulk payment for said entity implementing said carbon offsetting application;
receiving said single bulk payment for said entity implementing said carbon offsetting application from said at least one merchant; and
delivering said single bulk payment to said entity implementing said carbon offsetting application.

6. The method of claim 1 further comprising:
providing at least one shipping carrier that ships said at least one product; and
interacting with said at least one shipping carrier instead of interacting with said at least one merchant website such that said shipping carrier interacts with said at least one merchant website with data supplied by, and as an intermediary for, said method to offset carbon emissions generated by shipping at least one product purchased via interaction with a web enabled network system.

7. The method of claim 1 further comprising permitting said at least one customer to optionally select to include said estimated cost to offset said estimated amount of carbon emissions generated from shipping said at least one product in said total cost such that said at least a portion of said estimated cost to offset said estimated carbon emissions is delivered after said at least one product is purchased if said at least one customer selected to include said estimated cost to offset said estimated amount of carbon emissions and no payment is delivered if said at least one customer does not select to include said estimated cost to offset said estimated amount of carbon emissions in said total cost.

8. The method of claim 1 further comprising:
delivering said estimated amount of carbon emissions generated from shipping said at least one product to said shopping cart subsystem from said carbon offset subsystem; and
displaying said estimated amount of carbon emissions generated from shipping said at least one product to said at least one customer in said shopping cart subsystem.

9. The method of claim 1 further comprising:
displaying a plurality of potential carbon offsetting applications to said customer via said carbon offset subsystem of said shopping cart subsystem of said merchant website;
selecting by said customer of a desired carbon offsetting application from said plurality of potential carbon offsetting applications; and
delivering said sub-portion of said portion of said estimated cost to offset said estimated amount of carbon emissions generated from shipping said at least one product to said desired carbon offsetting application.

10. The method of claim 9 wherein said plurality of carbon offsetting applications comprises at least one of the group comprising: wind energy production, solar energy production, geothermal energy production, tidal energy production, ocean/water wave energy production, bio matter carbon dioxide sequestration, tree carbon dioxide sequestration, geological carbon sequestration, general carbon offsets, general carbon credits, a specific individual carbon offset application, European Union Emission Trading Scheme credits, Kyoto Protocol credits, Certified Emission Redutions (CERs), European Union Allowances (EUAs), Assigned Amount Units (AAUs), Emission Reduction Units (ERUs), Temporary Certified Emission Reductions (tCERs), and Pre-registered Emission Reductions (pre-CERs).

11. The method of claim 1 wherein said carbon emissions comprise at least one of the group comprising: carbon dioxide, carbon dioxide equivalents (CO2e), Kyoto Protocol Greenhouse Gases, and other Greenhouse Gases.

12. The method of claim 1 wherein said shipping information further comprises dimensional weight information and wherein said process of calculating by said carbon offset subsystem said estimated amount of carbon emissions generated from shipping said at least one product further incorporates said dimensional weight information.

13. The method of claim 1 further comprising running a database server application on said central computer system, said database server application providing a data storage and retrieval system for calculation factors utilized in said process of calculating by said carbon offset subsystem said estimated amount of carbon emissions generated from shipping said at least one product and in said process of calculating by said carbon offset system said estimated cost to offset said estimated amount of carbon emissions generated from shipping said at least one product.

14. The method of claim 1 wherein said web enabled network system is a publically accessible Internet system.

15. The method of claim 1 wherein said process of calculating by said carbon offset subsystem said estimated amount of carbon emissions generated from shipping said at least one product further incorporates additional computation factors.

16. The method of claim 15 wherein said additional computation factors comprises at least one of the group comprising: factors for circuit routing of shipping transportation vehicle, factors for said shipping transportation vehicle capacity, factors for transportation utilization of said shipping transportation vehicle, factors for empty miles of said shipping transportation vehicle, factors for utilizing a hub system when shipping, factors for fuel combustion of said shipping transportation vehicle, factors for pre-combustion of said shipping transportation vehicle, factors for vehicle non-fuel combustion of said shipping transportation vehicle, factors for infrastructure additions to carbon emissions for said shipping transportation vehicle, factors for accounting for model year of said shipping transportation vehicle, and factors for differentiating between shipping companies selected to ship said at least one product.

17. The method of claim 1 wherein said transportation method for shipping said at least one product incorporates multiple types of transportation such that different segments of shipping said at least one product are associated with different types of transportation in said process of calculating by said carbon offset subsystem said estimated amount of carbon emissions generated from shipping said at least one product.

18. The method of claim 17 wherein said different types of transportation comprise at least one of the group comprising: short-distance road transportation, long-distance road transportation, rail transportation, air transportation, and water born ship transportation.

19. A shipping emissions offset system to offset carbon emissions generated by shipping at least one product purchased via interaction with a web enabled network system comprising:
said web enabled network system;
at least one customer interacting with said web enabled network system;
at least one merchant website operated by at least one merchant on said web enabled network system, said merchant website having a shopping cart subsystem that provides a purchasing interface for said at least one customer to purchase said at least one product and to define shipping instructions to ship said at least one product;
a central computer system that has computer readable storage media for storing software programs and other data utilized during operation of said software programs;
an application server program running on said central computer system;
a carbon offset subsystem provided by said application server program to said shopping cart subsystem of said at least one merchant website;
a shipping information receiving subsystem of said carbon offset subsystem that receives shipping information about said at least one product being purchased by said at least one customer from said shopping cart subsystem of said merchant website, said shipping information being at least a weight of said at least one product, distance information that defines a distance that said at least one product is shipped, and a transportation method for shipping of said at least one product;
an estimated carbon emissions calculation subsystem of said carbon offset subsystem that calculates an estimated amount of carbon emissions generated from shipping said at least one product such that said calculation of said estimated amount of carbon emissions is based on said weight of said at least one product, said distance information that defines said distance that said at least one product is shipped, and said transportation method for shipping said at least one product of said shipping information;
an estimated carbon offset cost subsystem of said carbon offset subsystem that calculates an estimated cost to offset said calculated estimated amount of carbon emissions generated from shipping said at least one product;
a cost delivery subsystem of said carbon offset subsystem that delivers said estimated cost to offset said estimated amount of carbon emissions generated from shipping said at least one product from said carbon offset subsystem to said shopping cart subsystem such that said shopping cart subsystem includes said estimated cost to offset said estimated carbon emissions in a total cost to purchase and ship said at least one product; and
a payment subsystem that receives at least a portion of said estimated cost to offset said estimated amount of carbon emissions generated from shipping said at least one product from said at least one merchant after said at least one product has been purchased by said at least one customer and delivers at least a sub-portion of said portion of said estimated cost to offset said estimated amount of carbon emissions generated from shipping said at least one product to an entity implementing a carbon offsetting application.

20. The shipping emissions offset system of claim 19 wherein said distance information comprises at least one of the group comprising: a distance that said at least one product is to be shipped, an origination location where said at least one product is shipped from, a destination to ship said at least one product, a warehouse where said at least one product is to ship from, a list of warehouses where said at least one product may ship from, a default distance based product identification string, and a default distance.

21. The shipping emissions offset system of claim 19 wherein said shipping information additionally comprises at least one of the group comprising: product weight type, product identification, multiple leg data, multiple shipment data, emission identification, and merchant identification.

22. The shipping emissions offset system of claim 19 wherein said payment subsystem delivers a second sub-portion of said portion of said estimated cost to offset said estimated amount of carbon emissions generated from shipping said at least one product to a second entity that manages operation of said shipping emissions offset system.

23. The shipping emissions offset system of claim 19 wherein said payment subsystem further allocates said sub-portion of said portion of said estimated cost to offset said estimated amount of carbon emissions generated from shipping said at least one product to said entity implementing said carbon offsetting application; consolidates a plurality of sub-portions allocated to said entity implementing said carbon offsetting application into a single bulk payment for said entity implementing said carbon offsetting application; receives said single bulk payment for said entity implementing said carbon offsetting application from said at least one merchant; and delivers said single bulk payment to said entity implementing said carbon offsetting application.

24. The shipping emissions offset system of claim 19 further comprising:
at least one shipping carrier that ships said at least one product; and
a shipping carrier intermediary subsystem that interacts with said at least one shipping carrier instead of interacting with said at least one merchant website such that said shipping carrier interacts with said at least one merchant website with data supplied by, and as an intermediary for, said shipping emissions offset system.

25. The shipping emissions offset system of claim 19 further comprising a include carbon offset in cost subsystem that permits said at least one customer to optionally select to include said estimated cost to offset said estimated amount of carbon emissions generated from shipping said at least one product in said total cost such that said at least a portion of said estimated cost to offset said estimated carbon emissions is delivered after said at least one product is purchased if said at least one customer selected to include said estimated cost to offset said estimated amount of carbon emissions and no payment is delivered if said at least one customer does not select to include said estimated cost to offset said estimated amount of carbon emissions in said total cost.

26. The shipping emissions offset system of claim 19 further comprising a display carbon emissions subsystem that delivers said estimated amount of carbon emissions generated from shipping said at least one product to said shopping cart subsystem from said carbon offset subsystem and displays said estimated amount of carbon emissions generated from shipping said at least one product to said at least one customer in said shopping cart subsystem.

27. The shipping emissions offset system of claim 19 further comprising a carbon offset application selection subsystem that displays a plurality of potential carbon offsetting applications to said customer via said carbon offset subsystem of said shopping cart subsystem of said merchant website, accepts a selection by said customer of a desired carbon offsetting application selected from said plurality of potential carbon offsetting applications, and delivers said sub-portion of said portion of said estimated cost to offset said estimated amount of carbon emissions generated from shipping said at least one product to said desired carbon offsetting application.

28. The shipping emissions offset system of claim 27 wherein said plurality of carbon offsetting applications comprises at least one of the group comprising: wind energy production, solar energy production, geothermal energy production, tidal energy production, ocean/water wave energy production, bio matter carbon dioxide sequestration, tree carbon dioxide sequestration, geological carbon sequestration, general carbon offsets, general carbon credits, a specific individual carbon offset application, European Union Emission Trading Scheme credits, Kyoto Protocol credits, Certified Emission Redutions (CERs), European Union Allowances (EUAs), Assigned Amount Units (AAUs), Emission Reduction Units (ERUs), Temporary Certified Emission Reductions (tCERs), and Pre-registered Emission Reductions (pre-CERs).

29. The shipping emissions offset system of claim 19 wherein said carbon emissions comprise at least one of the group comprising: carbon dioxide, carbon dioxide equivalents (CO2e), Kyoto Protocol Greenhouse Gases, and other Greenhouse Gases.

30. The shipping emissions offset system of claim 19 wherein said shipping information further comprises dimensional weight information and wherein said estimated carbon emissions calculation subsystem further incorporates said dimensional weight information.

31. The shipping emissions offset system of claim 19 further comprising a database server application running on said central computer system that provides a data storage and retrieval system for calculation factors utilized in said estimated carbon emissions calculation subsystem and in said estimated carbon offset cost subsystem.

32. The shipping emissions offset system of claim 19 wherein said web enabled network system is a publically accessible Internet system.

33. The shipping emissions offset system of claim 19 wherein said estimated carbon emissions calculation subsystem further incorporates additional computation factors.

34. The shipping emissions offset system of claim 33 wherein said additional computation factors comprises at least one of the group comprising: factors for circuit routing of shipping transportation vehicle, factors for said shipping transportation vehicle capacity, factors for transportation utilization of said shipping transportation vehicle, factors for empty miles of said shipping transportation vehicle, factors for utilizing a hub system when shipping, factors for fuel combustion of said shipping transportation vehicle, factors for pre-combustion of said shipping transportation vehicle, factors for vehicle non-fuel combustion of said shipping transportation vehicle, factors for infrastructure additions to carbon emissions for said shipping transportation vehicle, factors for accounting for model year of said shipping transportation vehicle, and factors for differentiating between shipping companies selected to ship said at least one product.

35. The shipping emissions offset system of claim 19 wherein said transportation method for shipping said at least one product incorporates multiple types of transportation such that different segments of shipping said at least one product are associated with different types of transportation in said estimated carbon emissions calculation subsystem.

36. The shipping emissions offset system of claim 35 wherein said different types of transportation comprise at least one of the group comprising: short-distance road transportation, long-distance road transportation, rail transportation, air transportation, and water born ship transportation.

37. A system to offset carbon emissions generated by shipping at least one product purchased via interaction with a web enabled network system comprising:
means for providing said web enabled network system;
means for providing at least one customer interacting with said web enabled network system;
means for providing at least one merchant website operated by at least one merchant on said web enabled network system, said merchant website having a shopping cart subsystem that provides a purchasing interface for said at least one customer to purchase said at least one product and to define shipping instructions to ship said at least one product;
means for providing a central computer system that has computer readable storage media for storing software programs and other data utilized during operation of said software programs;
means for running an application server program on said central computer system;
means for providing a carbon offset subsystem to said shopping cart subsystem of said at least one merchant website;
means for receiving by said carbon offset subsystem shipping information about said at least one product being purchased by said at least one customer from said shopping cart subsystem of said merchant website, said shipping information being at least a weight of said at least one product, distance information that defines a distance that said at least one product is shipped, and a transportation method for shipping of said at least one product;
means for calculating by said carbon offset subsystem an estimated amount of carbon emissions generated from shipping said at least one product such that said calculation of said estimated amount of carbon emissions is based on said weight of said at least one product, said distance information that defines said distance that said at least one product is shipped, and said transportation method for shipping said at least one product of said shipping information;
means for calculating by said carbon offset subsystem an estimated cost to offset said calculated estimated amount of carbon emissions generated from shipping said at least one product;
means for delivering said estimated cost to offset said estimated amount of carbon emissions generated from shipping said at least one product from said carbon offset subsystem to said shopping cart subsystem such that said shopping cart subsystem includes said estimated cost to offset said estimated carbon emissions in a total cost to purchase and ship said at least one product;
means for receiving at least a portion of said estimated cost to offset said estimated amount of carbon emissions generated from shipping said at least one product; and
means for delivering at least a sub-portion of said portion of said estimated cost to offset said estimated amount of carbon emissions generated from shipping said at least one product to an entity implementing a carbon offsetting application.
